(19) United States
(12) Patent Application Publication
(10) Pub. No.: US 2024/0321319 A1
(43) Pub. Date: Sep. 26, 2024

(54) MEDIA SYNCHRONIZATION CONTROL APPARATUS, MEDIA SYNCHRONIZATION CONTROL METHOD, AND MEDIA SYNCHRONIZATION CONTROL PROGRAM

(71) Applicant: NIPPON TELEGRAPH AND TELEPHONE CORPORATION, Tokyo (JP)

(72) Inventors: Maiko IMOTO, Musashino-shi, Tokyo (JP); Shinji FUKATSU, Musashino-shi, Tokyo (JP)

(73) Assignee: NIPPON TELEGRAPH AND TELEPHONE CORPORATION, Tokyo (JP)

(21) Appl. No.: 18/574,334

(22) PCT Filed: Jul. 7, 2021
(86) PCT No.: PCT/JP2021/025651

§ 371 Date: Dec. 27, 2023

(51) Int. Cl. G11B 27/10

(52) U.S. Cl. CPC G11B 27/10

(57) ABSTRACT

In an embodiment, a medium synchronization control device is a device of a first base, including a first reception unit that receives, from an electronic device in each second base, a first packet that stores a second medium acquired in a second base at a time at which a first medium acquired at each time in the first base is reproduced in the second base, and stores the second medium in a storage unit in association with an acquisition time of the first medium regarding the second medium, and a medium synchronization control unit that simultaneously outputs the second medium regarding a plurality of second bases associated with one acquisition time stored in the storage unit to a presentation device.

### TECHNICAL FIELD

One aspect of the present invention relates to a medium synchronization control device, a medium synchronization control method, and a medium synchronization control program.

### BACKGROUND ART

In recent years, a video/audio reproduction device that digitizes a video/audio obtained by capturing and recording at a certain point, transmits the digitized video/audio to a remote location in real time via a communication line such as an Internet Protocol (IP) network, and reproduces the video/audio in the remote location has been used. For example, public viewing or the like in which a video/audio of a sports competition held at a competition site or a video/audio of a music concert held at a concert site are transmitted to a remote location in real time is actively performed. Such video/audio transmission is not limited to one-to-one unidirectional transmission. Bidirectional transmission is also performed in which a video/audio is transmitted from a site where a sports competition is held (hereinafter, referred to as an event site) to a plurality of remote locations, a video of an audience who enjoys the event and an audio of cheers and the like are obtained by capturing and recording in each of the plurality of remote locations, the video/audio is transmitted to the event site or another remote location, and the video/audio are output from a large video display device or a speaker at each base.

By such bidirectional transmission of a video/audio, players (or performers) and an audience in an event site, and viewers in a plurality of remote locations can obtain a realistic feeling and a sense of unity as if they were in the same space (event site) and having the same experience even though they were physically located away from each other.

A real-time transport protocol (RTP) is often used in real-time transmission of a video/audio by an IP network, but a data transmission time between two bases varies depending on a communication line or the like connecting the two bases. For example, a case is considered in which a video/audio obtained by capturing and recording at a time T at an event site A is transmitted to two remote locations B and C, and a video/audio obtained by capturing and recording in each of the remote locations B and C is returned and transmitted to the event site A. The video/audio obtained by capturing and recording at the time T and transmitted from the event site A in the remote location B is reproduced at a time I_{b1}, and a video/audio obtained by capturing and recording at the time T_{b1} in the remote location B is returned and transmitted to the event site A and reproduced at a time T_{b2} at the event site A. At this time, the video/audio obtained by capturing and recording at the time T and transmitted at the event site A may be reproduced at a time T_{c1} (≠T_{b1}) in the remote location C and a video/audio obtained by capturing and recording at the time T_{c1} in the remote location C may be returned and transmitted to the event site A and reproduced at a time T_{c2} (≠T_{b2}) at the event site A.

In such a case, players (or performers) and an audience in the event site A view videos/audios indicating how viewing in the plurality of remote locations has reacted to an event experienced by themselves at the time T at different times (time T_{b2} and time T_{c2}). For the players (or performers) and the audience in the event site A, enhancing a sense of unity with the audience in the remote locations may be difficult because lack of intuitive comprehension or unnaturalness of connection with their own experience is caused. Furthermore, also when the video/audio transmitted from the event site A and the video/audio transmitted from the remote location B are reproduced in the remote location C, the audience in the remote location C may feel the above-described lack of intuitive comprehension or unnaturalness.

In order to eliminate such lack of intuitive comprehension or unnaturalness, conventionally, a method of synchronously reproducing a plurality of videos/plurality of audios transmitted from a plurality of remote locations in the event site A is used. In a case where reproduction timings of videos/audios are synchronized, time synchronization is performed using a network time protocol (NTP), a precision time protocol (PTP), or the like so that both the transmission side and the reception side manage the same time information, and video/audio data is packetized into RTP packets at the time of transmission. At this time, in general, an absolute time of a moment of sampling the videos/audios is provided as an RTP time stamp, and the reception side delays at least one or more videos and audios of videos and audios on the basis of the time information to adjust timings, and synchronizes the videos/audios (Non Patent Literature 1).

### CITATION LIST

### Non Patent Literature

Non Patent Literature 1: Synchronization for Acoustic Signals over IP Network (Tokumoto, Ikedo, Kaneko, Kataoka, the transactions of the Institute of Electronics, Information and Communication Engineers D-II Vol. J87-D-II No. 9 pp. 1870-1883)

### SUMMARY OF INVENTION

### Technical Problem

However, in the conventional video/audio reproduction synchronization method, appropriately synchronously reproducing, at one base, videos/audios that are returned and transmitted from a plurality of remote locations in one-to-many bidirectional transmission is difficult. Even if absolute times of moments of sampling are provided to videos/audios obtained by capturing and recording at a plurality of remote locations, there is not always relationship between the videos/audios obtained by capturing and recording at the remote locations at the absolute times. For example, in the above-described example, different scenes of a video/audio transmitted from the event site A are viewed in a video/audio obtained by capturing and recording at a time T_{b1} at the remote location B and a video/audio obtained by capturing and recording at the time T_{b1} at the remote location C, and even if these return videos/audios are synchronously reproduced at the event site A, the above-described lack of intuitive comprehension and unnaturalness cannot be solved. In the event site A, the return video/audio obtained by capturing and recording at the time T_{b1} at the remote location B and a return video/audio obtained by capturing and recording at the time T_{c1} at the remote location C are desirably synchronously reproduced.

The present invention has been made in view of the above circumstances, and an object of the present invention is to provide a technology for appropriately synchronously reproducing a plurality of videos/audios returned and transmitted from a plurality of bases through different transmission paths.

### Solution to Problem

In an embodiment of the present invention, a medium synchronization control device is a device of a first base, including a first reception unit that receives, from an electronic device in each second base, a first packet that stores a second medium acquired in a second base at a time at which a first medium acquired at each time in the first base is reproduced in the second base, and stores the second medium in a storage unit in association with an acquisition time of the first medium regarding the second medium, and a medium synchronization control unit that simultaneously outputs the second medium regarding a plurality of second bases associated with one acquisition time stored in the storage unit to a presentation device.

### Advantageous Effects of Invention

According to one aspect of the present invention, a plurality of videos/audios that are returned and transmitted from a plurality of bases through different transmission paths can be appropriately synchronously reproduced.

### BRIEF DESCRIPTION OF DRAWINGS

FIG. 1 is a block diagram illustrating an example of a hardware configuration of each electronic device included in a medium synchronization system according to a first embodiment.

FIG. 2 is a block diagram illustrating an example of a software configuration of each electronic device included in the medium synchronization system according to the first embodiment.

FIG. 3 is a diagram illustrating an example of a data structure of a video synchronization control DB included in a server of a base O according to the first embodiment.

FIG. 4 is a diagram illustrating an example of a data structure of an audio time control DB included in the server of the base O according to the first embodiment.

FIG. 5 is a diagram illustrating an example of a data structure of a video time management DB included in a server of a base R₁ according to the first embodiment.

FIG. 6 is a diagram illustrating an example of a data structure of an audio time management DB included in the server of the base R₁ according to the first embodiment.

FIG. 7 is a flowchart illustrating a video processing procedure and processing content of the server in the base O according to the first embodiment.

FIG. 8 is a flowchart illustrating a video processing procedure and processing content of the server in the base R₁ according to the first embodiment.

FIG. 9 is a flowchart illustrating a transmission processing procedure and processing content of an RTP packet that stores a video V_{signal1} of the server in the base O according to the first embodiment.

FIG. 10 is a flowchart illustrating a reception processing procedure and processing content of an RTP packet that stores a video V_{signal1} of the server in the base R₁ according to the first embodiment.

FIG. 11 is a flowchart illustrating a calculation processing procedure and processing content of a presentation time t₁ of the server in the base R₁ according to the first embodiment.

FIG. 12 is a flowchart illustrating a transmission processing procedure and processing content of an RTP packet that stores a video V_{signal2} of the server in the base R₁ according to the first embodiment.

FIG. 13 is a flowchart illustrating a reception processing procedure and processing content of an RTP packet that stores a video V_{signal2} of the server in the base O according to the first embodiment.

FIG. 14 is a flowchart illustrating a synchronization processing procedure and processing content of videos V_{signal2} of the server in the base O according to the first embodiment.

FIG. 15 is a flowchart illustrating an audio processing procedure and processing content of the server in the base O according to the first embodiment.

FIG. 16 is a flowchart illustrating an audio processing procedure and processing content of the server in the base R₁ according to the first embodiment.

FIG. 17 is a flowchart illustrating a transmission processing procedure and processing content of an RTP packet that stores an audio A_{signal1} of the server in the base O according to the first embodiment.

FIG. 18 is a flowchart illustrating a reception processing procedure and processing content of an RTP packet that stores an audio A_{signal1} of the server in the base R₁ according to the first embodiment.

FIG. 19 is a flowchart illustrating a transmission processing procedure and processing content of an RTP packet that stores an audio A_{signal1} of the server in the base R₁ according to the first embodiment.

FIG. 20 is a flowchart illustrating a reception processing procedure and processing content of an RTP packet that stores an audio A_{signal2} of the server in the base O according to the first embodiment.

FIG. 21 is a flowchart illustrating a synchronization processing procedure and processing content of audios A_{signal2} of the server in the base O according to the first embodiment.

FIG. 22 is a block diagram illustrating an example of a software configuration of each electronic device included in a medium synchronization system according to a second embodiment.

FIG. 23 is a flowchart illustrating a video processing procedure and processing content of a server in a base O according to the second embodiment.

FIG. 24 is a flowchart illustrating a video processing procedure and processing content of a server in a base R₁ according to the second embodiment.

FIG. 25 is a flowchart illustrating a transmission processing procedure and processing content of an RTP packet that stores a video V_{signal2} of the server in the base R₁ according to the second embodiment.

FIG. 26 is a flowchart illustrating a transmission processing procedure and processing content of an RTCP packet that stores modified time information Δt_{video} of the server in the base R₁ according to the second embodiment.

FIG. 27 is a diagram illustrating a processing example by a video time modification transmission unit of the server in the base R according to the second embodiment.

FIG. 28 is a flowchart illustrating a reception processing procedure and processing content of an RTCP packet that stores modified time information Δt_{video} of the server in the base O according to the second embodiment.

FIG. 29 is a diagram illustrating a processing example by a video time modification notification unit of the server in the base R₁ according to the second embodiment.

FIG. 30 is a flowchart illustrating a reception processing procedure and processing content of an RTP packet that stores a video V_{signal2} of the server in the base O according to the second embodiment.

FIG. 31 is a flowchart illustrating an audio processing procedure and processing content of the server in the base O according to the second embodiment.

FIG. 32 is a flowchart illustrating an audio processing procedure and processing content of the server in the base R₁ according to the second embodiment.

FIG. 33 is a flowchart illustrating a transmission processing procedure and processing content of an RTP packet that stores an audio A_{signal2} of the server in the base R₁ according to the second embodiment.

FIG. 34 is a flowchart illustrating a transmission processing procedure and processing content of an RTCP packet that stores modified time information Δt_{audio} of the server in the base R₁ according to the second embodiment.

FIG. 35 is a flowchart illustrating a reception processing procedure and processing content of an RTCP packet that stores modified time information Δt_{audio} of the server in the base O according to the second embodiment.

FIG. 36 is a flowchart illustrating a reception processing procedure and processing content of an RTP packet that stores an audio A_{signal2} of the server in the base O according to the second embodiment.

### DESCRIPTION OF EMBODIMENTS

Hereinafter, some embodiments according to the present invention will be described with reference to the drawings.

Time information uniquely determined with respect to an absolute time at which a video/audio is obtained by capturing and recording in a base O serving as an event site such as a competition site or a concert site is used as time information for synchronously reproducing return videos/audios transmitted to bases R₁ to Rₙ (n is an integer of 2 or more) in a plurality of remote locations. In each of the bases R₁ to Rₙ, a video/audio obtained by capturing and recording at a time at which a video/audio having the time information is reproduced is associated with the time information. In the base O, all or a part of return videos/audios transmitted from the bases R₁ to Rₙ are synchronously reproduced on the basis of the time information.

The time information is transmitted and received between the base O and each of the bases R₁ to Rₙ by any one of the following means. The time information is associated with a video/audio obtained by capturing and recording in each of the bases R₁ to Rₙ.
(1) The time information is stored in a header extension area of an RTP packet transmitted and received between the base O and each of the bases R₁ to Rₙ. For example, the time information is in an absolute time format (hh:mm:ss.fff format), but may be in a millisecond format.
(2) The time information is described using an application-defined (APP) in an RTP control protocol (RTCP) transmitted and received at constant intervals between the base O and each of the bases R₁ to Rₙ. In this example, the time information is in a millisecond format.
(3) The time information is stored in a session description protocol (SDP) that describes initial value parameters exchanged between the base O and each of the bases R₁ to Rₙ at the start of transmission. In this example, the time information is in a millisecond format.

### First Embodiment

A first embodiment is an embodiment in which time information for synchronously reproducing return videos/audios is stored in header extension regions of RTP packets transmitted and received between the base O and the bases R₁ to Rₙ, thereby synchronously reproducing the return videos/audios from the bases R₁ to Rₙ in the base O.

Time information used for processing a video/audio is stored in a header extension area of an RTP packet transmitted and received between the base O and each of the bases R₁ to Rₙ. For example, the time information is in an absolute time format (hh:mm:ss.fff format).

Although a video and an audio are described as being transmitted and received in RTP packetization, the present invention is not limited thereto. The video and audio may be processed and managed by the same functional unit/database (DB). Both the video and audio may be stored in one RTP packet and transmitted and received. The video and audio are examples of a medium.

### (Configuration Example)

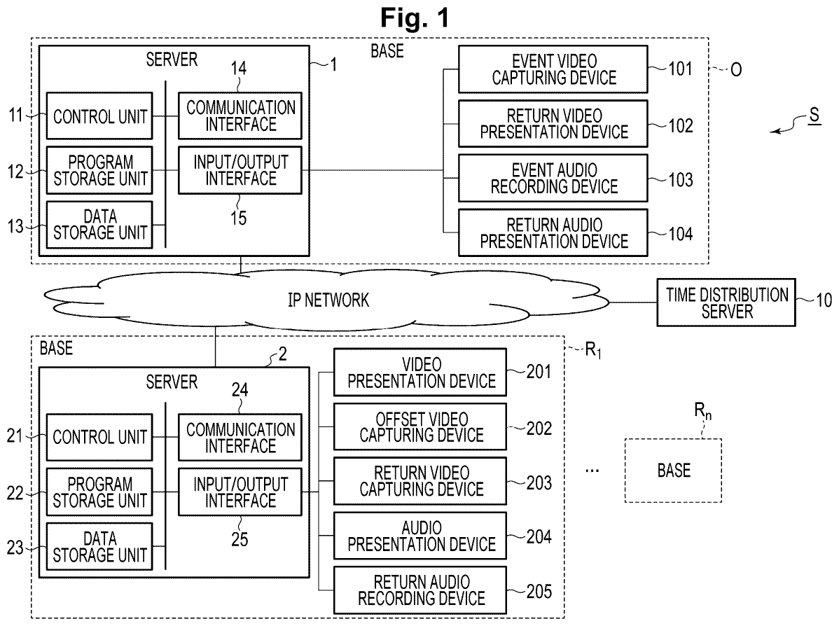

FIG. 1 is a block diagram illustrating an example of a hardware configuration of each electronic device included in a medium synchronization system S according to the first embodiment.

The medium synchronization system S includes a plurality of electronic devices included in the base O, a plurality of electronic devices included in each of the bases R₁ to Rₙ, and a time distribution server 10. The electronic devices in each of the bases and the time distribution server 10 can communicate with each other via an IP network. The bases R₁ to Rₙ are examples of second bases different from a first base. In order to refer to any one of the bases R₁ to Rₙ, the base may be referred to as a base R.

The base O includes a server 1, an event video capturing device 101, a return video presentation device 102, an event audio recording device 103, and a return audio presentation device 104. The base O is an example of a first base.

The server 1 is an electronic device that controls each of the electronic devices included in the base O. The server 1 is an example of a medium synchronization control device.

The event video capturing device 101 is a device including a camera that captures a video of the base O. The event video capturing device 101 is an example of a video capturing device.

The return video presentation device 102 is a device including a display that reproduces and displays a video returned and transmitted from each of the bases R₁ to Rₙ to the base O. For example, the display is a liquid crystal display. The return video presentation device 102 is an example of a video presentation device or a presentation device.

The event audio recording device 103 is a device including a microphone that records an audio of the base O. The event audio recording device 103 is an example of an audio recording device.

The return audio presentation device 104 is a device including a speaker that reproduces and outputs an audio returned and transmitted from each of the bases R₁ to Rₙ to the base O. The return audio presentation device 104 is an example of an audio presentation device or a presentation device.

A configuration example of the server 1 will be described.

The server 1 includes a control unit 11, a program storage unit 12, a data storage unit 13, a communication interface 14, and an input/output interface 15. The elements included in the server 1 are connected to each other via a bus.

The control unit 11 corresponds to a central part of the server 1. The control unit 11 includes a processor such as a central processing unit (CPU). The control unit 11 includes a read only memory (ROM) as a nonvolatile memory area. The control unit 11 includes a random access memory (RAM) as a volatile memory area. The processor deploys the ROM or a program stored in the program storage unit 12 in the RAM. The processor executes a program deployed in the RAM, thereby the control unit 11 implements each functional unit described below. The control unit 11 is included in a computer.

The program storage unit 12 includes a non-volatile memory capable of writing and reading as needed, such as a hard disk drive (HDD) or a solid state drive (SSD) as a storage medium. The program storage unit 12 stores programs necessary for executing various types of control processing. For example, the program storage unit 12 stores a program for causing the server 1 to execute processing by each functional unit to be described below implemented by the control unit 11. The program storage unit 12 is an example of a storage.

The data storage unit 13 includes a non-volatile memory capable of writing and reading as needed, such as an HDD or an SSD as a storage medium. The data storage unit 13 is an example of a storage or a storage unit.

The communication interface 14 includes various interfaces that communicatively connect the server 1 to other electronic devices using a communication protocol defined by the IP network.

The input/output interface 15 is an interface that enables communication between the server 1 and each of the event video capturing device 101, the return video presentation device 102, the event audio recording device 103, and the return audio presentation device 104. The input/output interface 15 may include an interface for wired communication or an interface for wireless communication.

Note that a hardware configuration of the server 1 is not limited to the above-described configuration. The server 1 can appropriately omit and change the above-described components and add a new component.

The base R₁ includes a server 2, a video presentation device 201, an offset video capturing device 202, a return video capturing device 203, an audio presentation device 204, and a return audio recording device 205.

The server 2 is an electronic device that controls each of the electronic devices included in the base R₁. The video presentation device 201 is a device including a display that reproduces and displays a video transmitted from the base O to the base R₁. The video presentation device 201 is an example of the presentation device.

The offset video capturing device 202 is a device capable of recording a capturing time. The offset video capturing device 202 is a device including a camera installed so as to be able to capture the entire video display area of the video presentation device 201. The offset video capturing device 202 is an example of the video capturing device.

The return video capturing device 203 is a device including a camera that captures a video of the base R₁. For example, the return video capturing device 203 captures a video of a state of the base R; where the video presentation device 201 that reproduces and displays a video transmitted from the base O to the base R₁ is installed. The return video capturing device 203 is an example of the video capturing device.

The audio presentation device 204 is a device including a speaker that reproduces and outputs an audio transmitted from the base O to the base R₁. The audio presentation device 204 is an example of the presentation device.

The return audio recording device 205 is a device including a microphone that records an audio of the base R₁. For example, the return audio recording device 205 records an audio of a state of the base R₁ where the audio presentation device 204 that reproduces and outputs an audio transmitted from the base O to the base R₁ is installed. The return audio recording device 205 is an example of the audio recording device.

A configuration example of the server 2 will be described.

The server 2 includes a control unit 21, a program storage unit 22, a data storage unit 23, a communication interface 24, and an input/output interface 25. The elements included in the server 2 are connected to each other via a bus.

The control unit 21 can be formed similarly to the control unit 11. A processor deploys a ROM or a program stored in the program storage unit 22 in a RAM. The processor executes a program deployed in the RAM, thereby the control unit 21 implements each functional unit described below. The control unit 21 is included in a computer.

The program storage unit 22 can be formed similarly to the program storage unit 12.

The data storage unit 23 can be formed similarly to the data storage unit 13.

The communication interface 24 can be formed similarly to the communication interface 14. The communication interface 14 includes various interfaces that communicatively connect the server 2 to other electronic devices.

The input/output interface 25 can be formed similarly to the input/output interface 15. The input/output interface 25 enables communication between the server 2 and each of the video presentation device 201, the offset video capturing device 202, the return video capturing device 203, the audio presentation device 204, and the return audio recording device 205.

Note that a hardware configuration of the server 2 is not limited to the above-described configuration. The server 2 can appropriately omit and change the above-described components and add a new component.

Since hardware configurations of a plurality of electronic devices included in each of bases R₂ to Rₙ are similar to those of the base R₁ described above, description thereof will be omitted.

The time distribution server 10 is an electronic device that manages a reference system clock. The reference system clock is an absolute time.

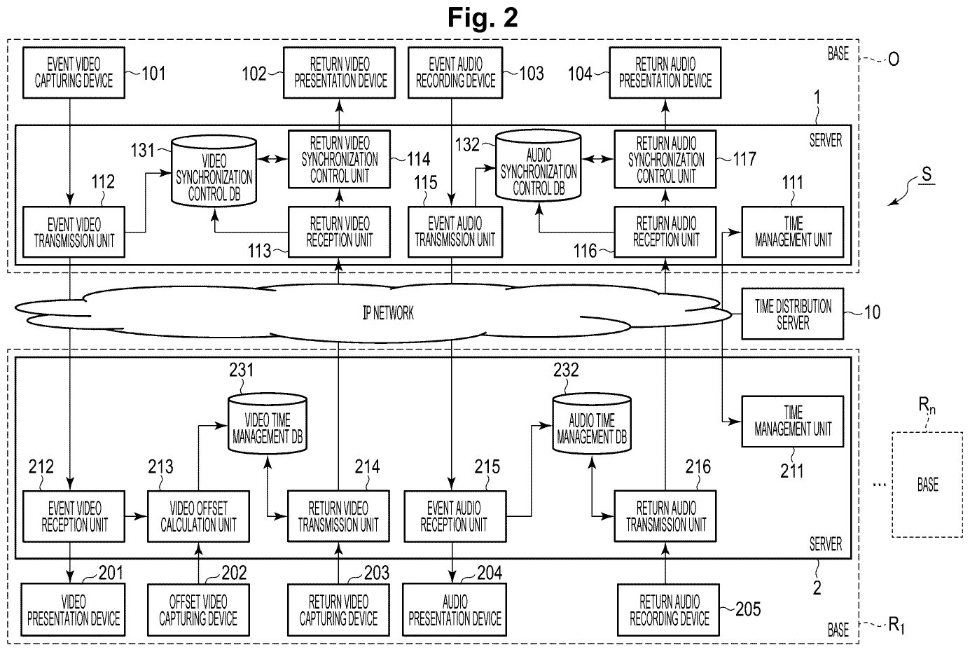

FIG. 2 is a block diagram illustrating an example of a software configuration of each of the electronic devices included in the medium synchronization system S according to the first embodiment.

The server 1 includes a time management unit 111, an event video transmission unit 112, a return video reception unit 113, a return video synchronization control unit 114, an event audio transmission unit 115, a return audio reception unit 116, a return audio synchronization control unit 117, a video synchronization control DB 131, and an audio synchronization control DB 132. Each functional unit is implemented by execution of a program by the control unit 11. It can also be said that each functional unit is included in the control unit 11 or the processor. Each functional unit can be read as the control unit 11 or the processor. The video synchronization control DB 131 and the audio synchronization control DB 132 are implemented by the data storage unit 13.

The time management unit 111 performs time synchronization with the time distribution server 10 using a known protocol such as NTP or PTP, and manages the reference system clock. The time management unit 111 manages the same reference system clock as the reference system clock managed by the server 2. The reference system clock managed by the time management unit 111 and the reference system clock managed by the server 2 are time-synchronized.

The event video transmission unit 112 transmits an RTP packet that stores a video V_{signal1} output from the event video capturing device 101 to each of servers of the bases R₁ to Rₙ via the IP network. The video V_{signal1} is a video acquired at a time T_{video} that is an absolute time in the base O. Acquiring the video V_{signal1} includes capturing the video V_{signal1} by the event video capturing device 101. Acquiring the video V_{signal1} includes sampling the video V_{signal1} obtained by capturing by the event video capturing device 101. A time T_{video} is provided to the RTP packet that stores the video V_{signal1}. The time T_{video} is a time at which the video V_{signal1} is acquired in the base O. The time T_{video} is time information for synchronizing return videos at the base O. The time T_{video} is an example of an acquisition time of the video V_{signal1}. Every time the RTP packet that stores the video V_{signal1} is transmitted, the event video transmission unit 112 stores the time T_{video} regarding the video V_{signal1} in the video synchronization control DB 131 to be described below. The video V_{signal1} is an example of a first video. The time T_{video} is an example of a first time. An RTP packet is an example of a packet. The RTP packet that stores the video V_{signal1} is an example of a second packet. The event video transmission unit 112 is an example of a transmission unit.

The return video reception unit 113 receives an RTP packet that stores a video V_{signal2} from each of servers of the bases R₁ to Rₙ via the IP network. The video V_{signal2} is a video acquired in the base R at a time at which a video V_{signal1} acquired at each time T_{video} in the base O is reproduced in the base R. Acquiring the video V_{signal2} includes capturing the video V_{signal2} by the return video capturing device 203. Acquiring the video V_{signal2} includes sampling the video V_{signal2} obtained by capturing by the return video capturing device 203. The time T_{video} regarding the video V_{signal2} is provided to the RTP packet that stores the video V_{signal2}. Every time the RTP packet that stores the video V_{signal2} is received, the return video reception unit 113 stores the video V_{signal2} in the video synchronization control DB 131 to be described below in association with the time T_{video} regarding the video V_{signal2}. The video V_{signal2} is an example of a second video. The RTP packet that stores the video V_{signal2} is an example of a first packet. The return video reception unit 113 is an example of a first reception unit.

The return video synchronization control unit 114 simultaneously outputs videos V_{signal2} regarding a plurality of bases R among the bases R₁ to Rₙ associated with one time T_{video} stored in the video synchronization control DB 131 to the return video presentation device 102. The return video synchronization control unit 114 is an example of a medium synchronization control unit.

The event audio transmission unit 115 transmits an RTP packet that stores an audio A_{signal1} output from the event audio recording device 103 to each of the servers of the bases R₁ to Rₙ via the IP network. The audio A_{signal1} is an audio acquired at a time T_{audio} that is an absolute time in the base O. Acquiring the audio A_{signal1} includes recording the audio A_{signal1} by the event audio recording device 103. Acquiring the audio A_{signal1} includes sampling the audio A_{signal1} obtained by recording by the event audio recording device 103. The time T_{audio} is provided to the RTP packet that stores the audio A_{signal1}. The time T_{audio} is a time at which the audio A_{signal1} is acquired in the base O. The time T_{audio} is time information for synchronizing return audios at the base O. The time T_{audio} is an example of an acquisition time of the audio A_{signal1}. Every time the RTP packet that stores the audio A_{signal1} is transmitted, the event audio transmission unit 115 stores the time T_{audio} regarding the audio A_{signal1} in the audio synchronization control DB 132 to be described below. The audio A_{signal1} is an example of a first audio. The time T_{audio} is an example of the first time. The RTP packet that stores the audio A_{signal1} is an example of the second packet. The event audio transmission unit 115 is an example of the transmission unit.

The return audio reception unit 116 receives the RTP packet that stores the audio A_{signal2} from each of the servers of the bases R₁ to Rₙ via the IP network. The audio A_{signal2} is an audio acquired in the base R at a time at which an audio A_{signal1} acquired at each time T_{audio} in the base O is reproduced in the base R. Acquiring the audio A_{signal2} includes recording the audio A_{signal2} by the return audio recording device 205. Acquiring the audio A_{signal2} includes sampling the audio A_{signal2} obtained by recording by the return audio recording device 205. The time T_{audio} regarding the audio A_{signal1} is provided to the RTP packet that stores the audio A_{signal2}. Every time the RTP packet that stores the audio A_{signal2} is received, the return audio reception unit 116 stores the audio A_{signal2} in the audio synchronization control DB 132 to be described below in association with the time T_{audio} regarding the audio A_{signal1}. The audio A_{signal2} is an example of a second audio. The RTP packet that stores the audio A_{signal2} is an example of the first packet. The return audio reception unit 116 is an example of the first reception unit.

The return audio synchronization control unit 117 simultaneously outputs audios A_{signal2} regarding a plurality of bases R among the bases R₁ to Rₙ associated with one time T_{audio} stored in the audio synchronization control DB 132 to the return audio presentation device 104. The return audio synchronization control unit 117 is an example of the medium synchronization control unit.

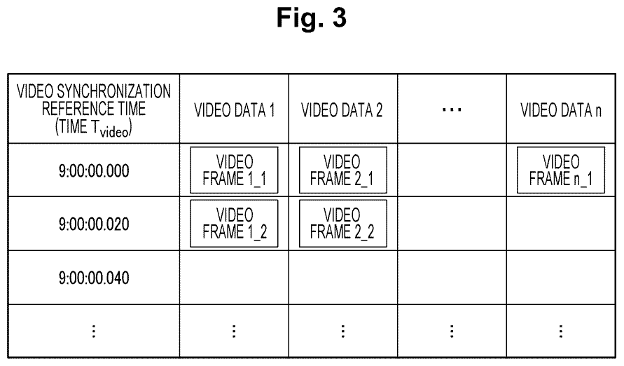

FIG. 3 is a diagram illustrating an example of a data structure of the video synchronization control DB 131 included in the server 1 of the base O according to the first embodiment.

The video synchronization control DB 131 stores times T_{video} and videos V_{signal2} stored in RTP packets received from the n bases R₁ to Rₙ by the return video reception unit 113 in association with each other.

The video synchronization control DB 131 includes a video synchronization reference time column and n video data columns regarding the bases R₁ to Rₙ. The video synchronization reference time column stores the times T_{video}. A video data 1 column is a column regarding the base R₁. The video data 1 column stores videos V_{signal2} returned and transmitted from the base R₁. Similarly, a video data n column is a column regarding the base Rₙ. The video data n column stores videos V_{signal2} returned and transmitted from the base Rₙ. A row number of a record of the video synchronization control DB 131 is set to r. r is an integer having an initial value of 0. The video synchronization control DB 131 is an example of a storage unit.

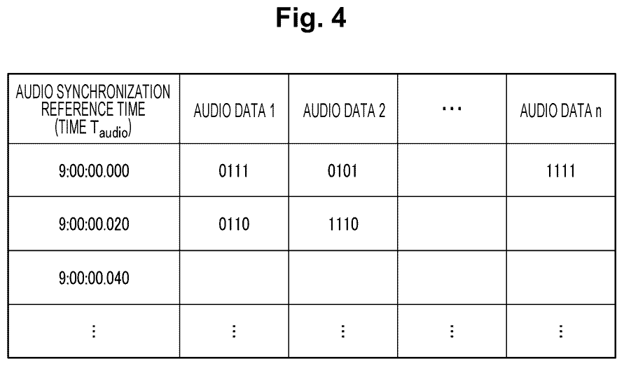

FIG. 4 is a diagram illustrating an example of a data structure of the audio synchronization control DB 132 included in the server 1 of the base O according to the first embodiment.

The audio synchronization control DB 132 stores times T_{audio} and audios A_{signal2} stored in RTP packets received from the n bases R₁ to Rₙ by the return audio reception unit 116 in association with each other.

The audio synchronization control DB 132 includes an audio synchronization reference time column and n audio data columns. The audio synchronization reference time column stores the times T_{audio}. An audio data 1 column stores audios A_{signal2} returned and transmitted from the base R₁. Similarly, an audio data n column stores audios A_{signal2} returned and transmitted from the base Rₙ. A row number of a record of the audio synchronization control DB 132 is set to r. r is an integer having an initial value of 0. The audio synchronization control DB 132 is an example of the storage unit.

The server 2 includes a time management unit 211, an event video reception unit 212, a video offset calculation unit 213, a return video transmission unit 214, an event audio reception unit 215, a return audio transmission unit 216, a video time management DB 231, and an audio time management DB 232. Each functional unit is implemented by execution of a program by the control unit 21. It can also be said that each functional unit is included in the control unit 21 or a processor. Each functional unit can be read as the control unit 21 or the processor. The video time management DB 231 and the audio time management DB 232 are implemented by the data storage unit 23.

The time management unit 211 performs time synchronization with the time distribution server 10 using a known protocol such as NTP or PTP, and manages the reference system clock. The time management unit 211 manages the same reference system clock as the reference system clock managed by the server 1. The reference system clock managed by the time management unit 211 and the reference system clock managed by the server 1 are time-synchronized.

The event video reception unit 212 receives an RTP packet that stores a video V_{signal1} from the server 1 via the IP network. The event video reception unit 212 outputs the video V_{signal1} to the video presentation device 201.

The video offset calculation unit 213 calculates a presentation time t₁ that is an absolute time at which the video V_{signal1} is reproduced by the video presentation device 201.

The return video transmission unit 214 transmits an RTP packet that stores a video V_{signal2} to the server 1 via the IP network. The RTP packet that stores the video V_{signal2} includes a time T_{video} associated with the presentation time t₁ that matches a time t that is an absolute time at which the video V_{signal2} is obtained by capturing.

The event audio reception unit 215 receives an RTP packet that stores an audio A_{signal1} from the server 1 via the IP network. The event audio reception unit 215 outputs the audio A_{signal1} to the audio presentation device 204. The return audio transmission unit 216 transmits an RTP packet that stores an audio A_{signal2} to the server 1 via the IP network. The RTP packet that stores the audio A_{signal2} includes a time T_{audio}.

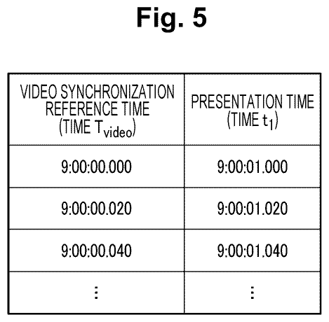

FIG. 5 is a diagram illustrating an example of a data structure of the video time management DB 231 included in the server 2 of the base R₁ according to the first embodiment.

The video time management DB 231 is a DB that stores times T_{video} acquired from the video offset calculation unit 213 and presentation times t₁ in association with each other.

The video time management DB 231 includes a video synchronization reference time column and a presentation time column. The video synchronization reference time column stores the times T_{video}. The presentation time column stores the presentation times t₁.

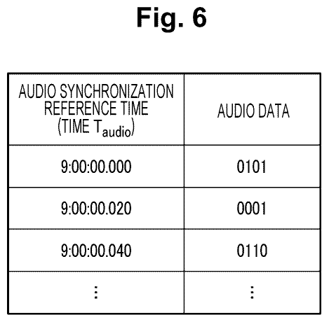

FIG. 6 is a diagram illustrating an example of a data structure of the audio time management DB 232 included in the server 2 of the base R₁ according to the first embodiment.

The audio time management DB 232 is a DB that stores times T_{audio} acquired from the event audio reception unit 215 and audios A_{signal1} in association with each other.

The audio time management DB 232 includes an audio synchronization reference time column and an audio data column. The audio synchronization reference time column stores the times T_{audio}. The audio data column stores the audios A_{signal1}.

Each of the servers of the bases R₂ to Rₙ includes functional units and a DB similar to those of the server 1 of the base R₁, and performs processing similar to that of the server 1 of the base R₁. Description of a processing flow and a DB structure of the functional units included in each of the servers of the bases R₂ to Rₙ will be omitted.

### (Operation Example)

Hereinafter, operation of the base O and the base R₁ will be described as an example. Operation of the bases R₂ to Rₙ may be similar to operation of the base R₁, and description thereof will be omitted. The notation of the base R₁ may be read as the bases R₂ to Rₙ.

### (1) Synchronize and Reproduce Return Videos

Video processing of the server 1 in the base O will be described.

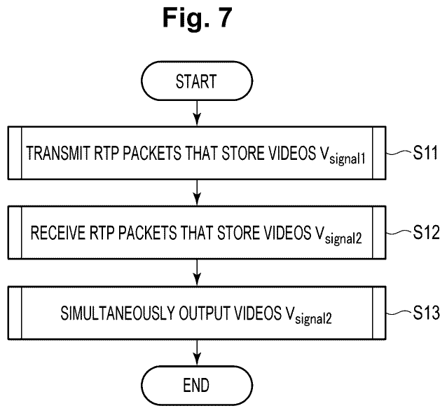

FIG. 7 is a flowchart illustrating a video processing procedure and processing content of the server 1 in the base O according to the first embodiment.

The event video transmission unit 112 transmits an RTP packet that stores a video V_{signal1} to each of the servers of the bases R via the IP network (step S11). A typical example of processing of step S11 will be described below.

The return video reception unit 113 receives an RTP packet that stores a video V_{signal2} from each of the servers of the bases R via the IP network (step S12). The return video reception unit 113 stores videos V_{signal2} in the video synchronization control DB 131 on the basis of times T_{video} stored in RTP packets that store the videos V_{signal2}. A typical example of processing of step S12 will be described below.

The return video synchronization control unit 114 simultaneously outputs videos V_{signal2} regarding a plurality of bases R among the bases R₁ to Rₙ associated with one time T_{video} stored in the video synchronization control DB 131 to the return video presentation device 102 (step S13). A typical example of processing of step S13 will be described below.

Video processing of the server 2 in the base R₁ will be described.

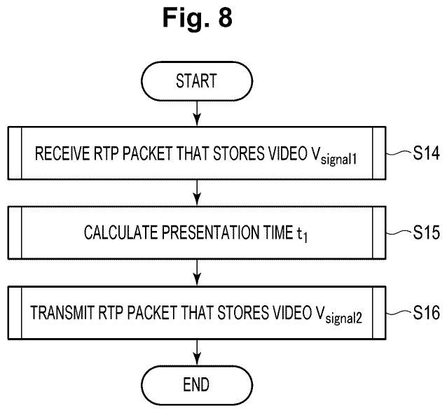

FIG. 8 is a flowchart illustrating a video processing procedure and processing content of the server 2 in the base R₁ according to the first embodiment.

The event video reception unit 212 receives an RTP packet that stores a video V_{signal1} from the server 1 via the IP network (step S14). A typical example of processing of step S14 will be described below.

The video offset calculation unit 213 calculates a presentation time t₁ at which the video V_{signal1} is reproduced by the video presentation device 201 (step S15). A typical example of processing of step S15 will be described below.

The return video transmission unit 214 transmits an RTP packet that stores a video V_{signal2} to the server 1 via the IP network (step S16). A typical example of processing of step S16 will be described below.

Hereinafter, typical examples of processing of steps S11 to S13 of the server 1 described above and processing of steps S14 to S16 of the server 2 described above will be described. In order of the processing in chronological order, the processing in step S11 of the server 1, the processing in step S14 of the server 2, the processing in step S15 of the server 2, the processing in step S16 of the server 2, the processing in step S12 of the server 1, and the processing in step S13 of the server 1 will be described in this order.

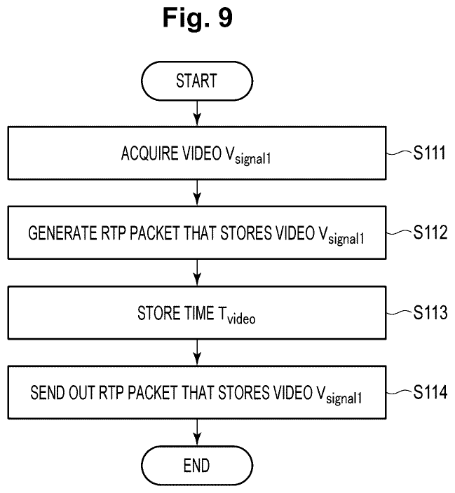

FIG. 9 is a flowchart illustrating a transmission processing procedure and processing content of an RTP packet that stores a video V_{signal1} of the server 1 in the base O according to the first embodiment. FIG. 9 illustrates the typical example of the processing of step S11.

The event video transmission unit 112 acquires a video V_{signal1} output from the event video capturing device 101 at constant intervals I_{video} (step S111).

The event video transmission unit 112 generates an RTP packet that stores the video V_{signal1} (step S112). In step S112, for example, the event video transmission unit 112 stores the acquired video V_{signal1} in an RTP packet. The event video transmission unit 112 acquires a time T_{video} that is an absolute time at which the video V_{signal1} is sampled from the reference system clock managed by the time management unit 111. The event video transmission unit 112 stores the acquired time T_{video} in the header extension area of the RTP packet.

The event video transmission unit 112 stores the acquired time T_{video} in the video synchronization reference time column of video synchronization control DB 131 (step S113).

The event video transmission unit 112 sends out the generated RTP packet that store the video V_{signal1} to the IP network (step S114).

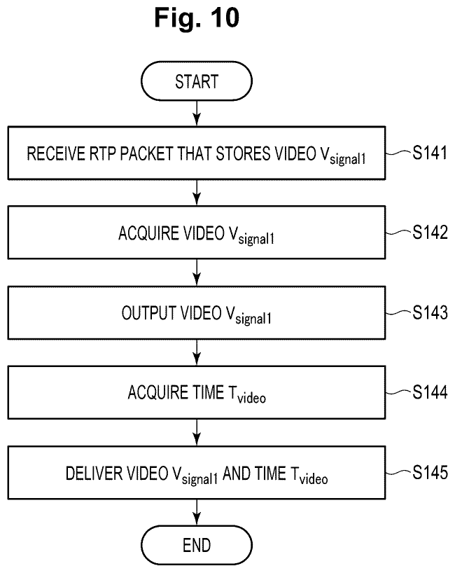

FIG. 10 is a flowchart illustrating a reception processing procedure and processing content of an RTP packet that stores a video V_{signal1} of the server 2 in the base R₁ according to the first embodiment. FIG. 10 illustrates the typical example of the processing of step S14 of the server 2.

The event video reception unit 212 receives an RTP packet that stores a video V_{signal1} sent out from the event video transmission unit 112 via the IP network (step S141).

The event video reception unit 212 acquires the video V_{signal1} stored in the received RTP packet that stores the video V_{signal1} (step S142).

The event video reception unit 212 outputs the acquired video V_{signal1} to the video presentation device 201 (step S143). The video presentation device 201 reproduces and displays the video V_{signal1}.

The event video reception unit 212 acquires a time T_{video} stored in the header extension area of the received RTP packet that stores the video V_{signal1} (step S144).

The event video reception unit 212 delivers the acquired video V_{signal1} and time T_{video} to the video offset calculation unit 213 (step S145).

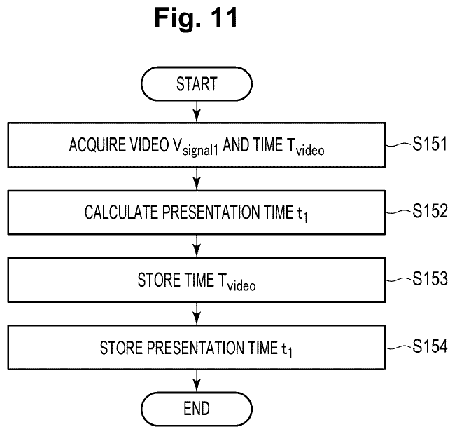

FIG. 11 is a flowchart illustrating a calculation processing procedure and processing content of a presentation time t₁ of the server 2 in the base R₁ according to the first embodiment. FIG. 11 illustrates the typical example of the processing of step S15 of the server 2.

The video offset calculation unit 213 acquires a video V_{signal1} and a time T_{video} from the event video reception unit 212 (step S151).

The video offset calculation unit 213 calculates a presentation time t₁ on the basis of the acquired video V_{signal1} and a video input from the offset video capturing device 202 (step S152). In step S152, for example, the video offset calculation unit 213 extracts a video frame including the video V_{signal1} from the video obtained by capturing by the offset video capturing device 202 using a known image processing technology. The video offset calculation unit 213 acquires a capturing time provided to the extracted video frame as the presentation time t₁. The capturing time is an absolute time.

The video offset calculation unit 213 stores the acquired time T_{video} in the video synchronization reference time column of the video time management DB 231 (step S153).

The video offset calculation unit 213 stores the acquired presentation time t₁ in the presentation time column of the video time management DB 231 (step S154).

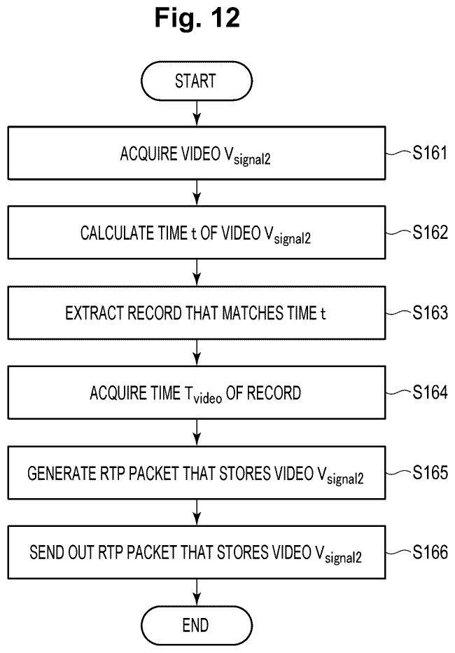

FIG. 12 is a flowchart illustrating a transmission processing procedure and processing content of an RTP packet that stores a video V_{signal2} of the server 2 in the base R₁ according to the first embodiment. FIG. 12 illustrates the typical example of the processing of step S16 of the server 2.

The return video transmission unit 214 acquires a video V_{signal2} output from the return video capturing device 203 at the constant intervals I_{video} (step S161). The video V_{signal2} is a video acquired in the base R₁ at a time at which the video presentation device 201 reproduces a video V_{signal1} acquired at each time T_{video} in the base O in the base R₁.

The return video transmission unit 214 calculates a time t that is an absolute time at which the acquired video V_{signal2} is obtained by capturing (step S162). In step S162, for example, in a case where a time code T_{c} (absolute time) representing a capturing time is provided to the video V_{signal2}, the return video transmission unit 214 acquires the time t as t=T_{c}. In a case where the time code T_{c} is not provided to the video V_{signal2}, the return video transmission unit 214 acquires a current time Tₙ from the reference system clock managed by the time management unit 211. The return video transmission unit 214 acquires the time t as t=Tₙ−t_{video_offset} using a predetermined value t_{video_offset} (positive number).

The return video transmission unit 214 refers to the video time management DB 231 and extracts a record having a time t₁ that matches the acquired time t (step S163).

The return video transmission unit 214 refers to the video time management DB 231 and acquires a time T_{video} in the video synchronization reference time column of the extracted record (step S164).

The return video transmission unit 214 generates an RTP packet that stores the video V_{signal2} (step S165). In step S165, for example, the return video transmission unit 214 stores the acquired video V_{signal2} in an RTP packet. The return video transmission unit 214 stores the acquired time T_{video} in the header extension area of the RTP packet.

The return video transmission unit 214 sends out the generated RTP packet that stores the video V_{signal2} to the IP network (step S166).

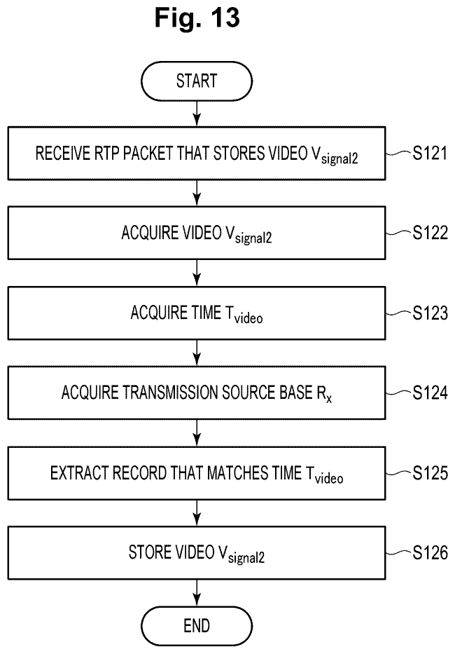

FIG. 13 is a flowchart illustrating a reception processing procedure and processing content of an RTP packet that stores a video V_{signal2} of the server 1 in the base O according to the first embodiment. FIG. 13 illustrates the typical example of the processing of step S12 of the server 1.

The return video reception unit 113 receives an RTP packet that stores a video V_{signal2} sent out from the return video transmission unit 214 via the IP network (step S121).

The return video reception unit 113 acquires the video V_{signal2} stored in the received RTP packet that stores the video V_{signal2} (step S122).

The return video reception unit 113 acquires a time T_{video} stored in the header extension area of the received RTP packet that stores the video V_{signal2} (step S123).

The return video reception unit 113 acquires a transmission source base Rₓ (x is any one of 1, 2, . . . , and n) from information stored in the header of the received RTP packet that stores the video V_{signal2} (step S124).

The return video reception unit 113 refers to the video synchronization control DB 131 and extracts a record in which a time T_{video} stored in the video synchronization reference time column matches the time T_{video} regarding the video V_{signal2} acquired from the RTP packet that stores the video V_{signal2} (step S125).

The return video reception unit 113 stores the acquired video V_{signal2} in the video data x column regarding the acquired transmission source base Rₓ in the extracted record (step S126). Storing the video V_{signal2} in a record of the video synchronization control DB 131 is an example of storing the video V_{signal2} in the video synchronization control DB 131 in association with the time T_{video}. For example, in a case where an RTP packet that stores a video V_{signal2} is received from the server 2 in the base R₁, the return video reception unit 113 stores the video V_{signal2} in the video data 1 column regarding the transmission source base R₁.

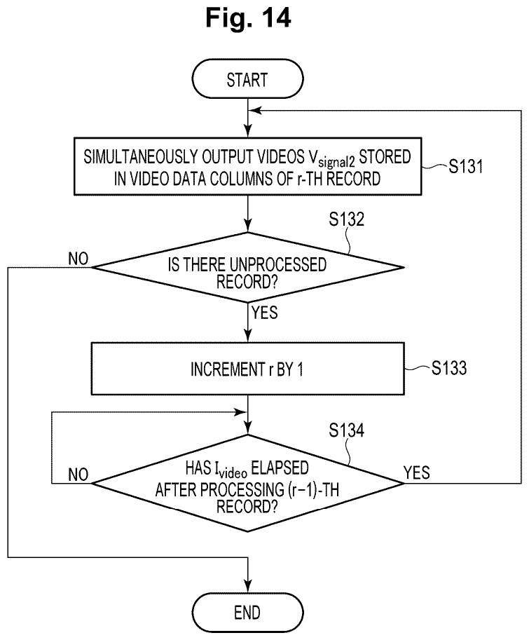

FIG. 14 is a flowchart illustrating a synchronization processing procedure and processing content of videos V_{signal2} of the server 1 in the base O according to the first embodiment. FIG. 14 illustrates the typical example of the processing of step S13 of the server 1.

The return video synchronization control unit 114 simultaneously outputs all videos V_{signal2} stored in the n video data columns of the r-th record in the video synchronization control DB 131 to the return video presentation device 102 (step S131). In step S131, for example, the return video synchronization control unit 114 starts processing from the 0th record. The return video synchronization control unit 114 starts outputting the videos V_{signal2} to the return video presentation device 102 after a lapse of a time t_{video_start} from a start timing of sending out RTP packets that store videos V_{signal1} by the event video transmission unit 112. For example, the time t_{video_start} may be a time from the start timing of sending out the RTP packets that store the videos V_{signal1} by the event video transmission unit 112 to when the videos V_{signal2} in all the n video data columns of the 0th record in the video synchronization control DB 131. In this example, the time t_{video_start} may be calculated by the return video synchronization control unit 114. The time t_{video_start} may be a predetermined value.

The return video synchronization control unit 114 extracts one row from the r-th record. The return video synchronization control unit 114 simultaneously outputs all videos V_{signal2} stored in the n video data columns of the r-th record to the return video presentation device 102. The r-th record is a record of one time T_{video}. All the videos V_{signal2} stored in the n video data columns of the r-th record are an example of videos V_{signal2} regarding a plurality of bases R among the bases R₁ to Rₙ associated with one time T_{video}.

The r-th record may store videos V_{signal2} in all of the n video data columns. In this example, videos V_{signal2} regarding all the bases R among the bases R₁ to Rₙ are stored in the r-th record. The return video synchronization control unit 114 simultaneously outputs all the videos V_{signal2} stored in all the n video data columns of the r-th record to the return video presentation device 102.

Videos V_{signal2} may be stored in a part of the n video data columns in the r-th record. In this example, videos V_{signal2} regarding a plurality of the bases R that is a part of the bases R₁ to Rₙ are stored in the r-th record. The return video synchronization control unit 114 simultaneously outputs all videos V_{signal2} stored in a plurality of video data columns that is a part of the n video data columns of the r-th record to the return video presentation device 102. In a video data column regarding a base R in which a video V_{signal2} of the r-th record is not stored, the return video synchronization control unit 114 may repeatedly output the video V_{signal2} regarding the base R output to the return video presentation device 102 in processing of the (r−1)-th record to the return video presentation device 102. When r is 0, the return video synchronization control unit 114 does not output a video V_{signal2} to the return video presentation device 102 in a video data column regarding a base R in which a video V_{signal2} of the 0th record is not stored.

The return video synchronization control unit 114 determines whether there is an unprocessed record in the video synchronization control DB 131 (step S132). In a case where there is no unprocessed record (NO in step S132), the processing ends. In a case where there is an unprocessed record (YES in step S132), the processing proceeds from step S132 to step S133.

The return video synchronization control unit 114 increments the row number r by 1 (step S133).

The return video synchronization control unit 114 determines whether the certain interval I_{video} has elapsed after the processing the (r−1)-th record (step S134). In a case where the interval I_{video} has not elapsed (NO in step S134), the return video synchronization control unit 114 repeats the processing of step S134. In a case where the interval I_{video} has elapsed (YES in step S134), the processing returns from step S134 to step S131.

As described above, the return video synchronization control unit 114 extracts records row by row at constant intervals I_{video} from the video synchronization control DB 131. Every time a record is extracted, the return video synchronization control unit 114 simultaneously outputs all videos V_{signal2} stored in the n video data columns of the extracted record to the return video presentation device 102. That is, even if there is an RTP packet that has not arrived at the base O by a reproduction time that is a processing time of the record, the return video synchronization control unit 114 simultaneously outputs all videos V_{signal2} that have arrived at the base O by the reproduction time to the return video presentation device 102. Even if an RTP packet arrives at the base O later than the reproduction time, the return video synchronization control unit 114 does not output a video V_{signal2} stored in the RTP packet to the return video presentation device 102.

### (2) Synchronize and Reproduce Return Audios

Audio processing of the server 1 in the base O will be described.

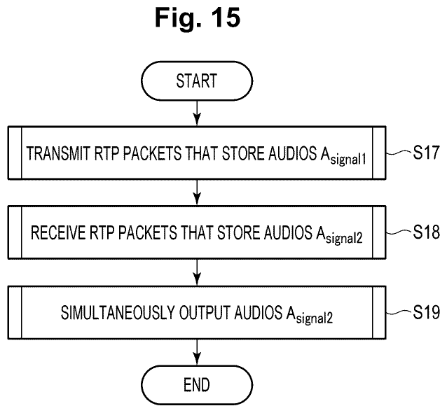

FIG. 15 is a flowchart illustrating an audio processing procedure and processing content of the server 1 in the base O according to the first embodiment.

The event audio transmission unit 115 transmits an RTP packet that stores an audio A_{signal1} to each of the servers of the bases R via the IP network (step S17). A typical example of processing of step S17 will be described below.

The return audio reception unit 116 receives the RTP packet that stores the audio A_{signal2} from each of the servers of the bases R via the IP network (step S18). The return audio reception unit 116 stores audios A_{signal2} in the audio synchronization control DB 132 on the basis of times T_{audio} stored in RTP packets that store the audios A_{signal2}. A typical example of processing of step S18 will be described below.

The return audio synchronization control unit 117 simultaneously outputs audios A_{signal2} regarding a plurality of bases R among the bases R₁ to Rₙ associated with one time T_{audio} stored in the audio synchronization control DB 132 to the return audio presentation device 104 (step S19). A typical example of processing of step S19 will be described below.

Audio processing of the server 2 in the base R₁ will be described.

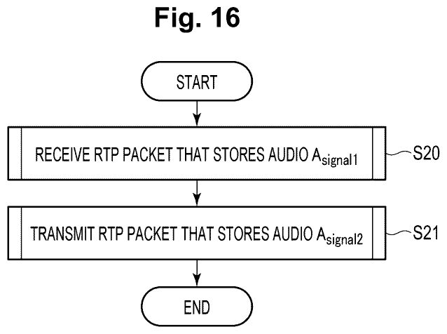

FIG. 16 is a flowchart illustrating an audio processing procedure and processing content of the server 2 in the base R₁ according to the first embodiment.

The event audio reception unit 215 receives an RTP packet that stores an audio A_{signal1} from the server 1 via the IP network (step S20). A typical example of processing of step S20 will be described below.

The return audio transmission unit 216 transmits an RTP packet that stores an audio A_{signal2} to the server 1 via the IP network (step S21). A typical example of processing of step S21 will be described below.

Hereinafter, typical examples of processing of steps S17 to S19 of the server 1 described above and processing of steps S20 to S21 of the server 2 described above will be described. In order of the processing in chronological order, the processing in step S17 of the server 1, the processing in step S20 of the server 2, the processing in step S21 of the server 2, the processing in step S18 of the server 1, and the processing in step S19 of the server 1 will be described in this order.

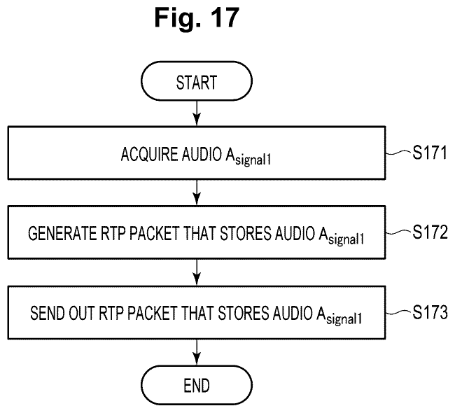

FIG. 17 is a flowchart illustrating a transmission processing procedure and processing content of an RTP packet that stores an audio A_{signal1} of the server 1 in the base O according to the first embodiment. FIG. 17 illustrates the typical example of the processing of step S17 of the server 1.

The event audio transmission unit 115 acquires an audio A_{signal1} output from the event audio recording device 103 at the constant interval I_{audio} (step S171).

The event audio transmission unit 115 generates an RTP packet that stores the audio A_{signal1} (step S172). In step S172, for example, the event audio transmission unit 115 stores the acquired audio A_{signal1} in an RTP packet. The event audio transmission unit 115 acquires a time T_{audio} that is an absolute time at which the audio A_{signal1} is sampled from the reference system clock managed by the time management unit 111. The event audio transmission unit 115 stores the acquired time T_{audio} in the header extension area of the RTP packet.

The event audio transmission unit 115 sends out the generated RTP packet that stores the audio A_{signal1} to the IP network (step S173).

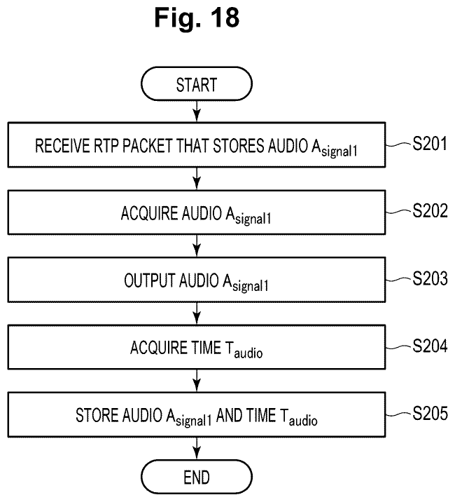

FIG. 18 is a flowchart illustrating a reception processing procedure and processing content of an RTP packet that stores an audio A_{signal1} of the server 2 in the base R₁ according to the first embodiment. FIG. 18 illustrates the typical example of the processing of step S20 of the server 2.

The event audio reception unit 215 receives an RTP packet that stores an audio A_{signal1} sent out from the event audio transmission unit 115 via the IP network (step S201).

The event audio reception unit 215 acquires the audio A_{signal1} stored in the received RTP packet that stores the audio A_{signal1} (step S202).

The event audio reception unit 215 outputs the acquired audio A_{signal1} to the audio presentation device 204 (step S203). The audio presentation device 204 reproduces and outputs the audio A_{signal1}.

The event audio reception unit 215 acquires a time T_{audio} stored in the header extension area of the received RTP packet that stores the audio A_{signal1} (step S204).

The event audio reception unit 215 stores the acquired audio A_{signal1} and time T_{audio} in the audio time management DB 232 (step S205). In step S205, for example, the event audio reception unit 215 stores the acquired time T_{audio} in the audio synchronization reference time column of the audio time management DB 232. The event audio reception unit 215 stores the acquired audio A_{signal1} in the audio data column of the audio time management DB 232.

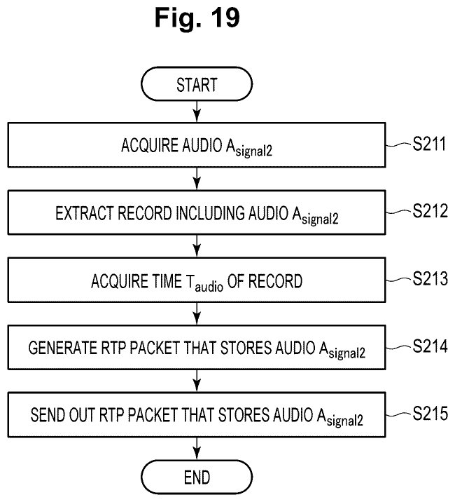

FIG. 19 is a flowchart illustrating a transmission processing procedure and processing content of an RTP packet that stores an audio A_{signal2} of the server 2 in the base R₁ according to the first embodiment. FIG. 19 illustrates the typical example of the processing of step S21 of the server 2.

The return audio transmission unit 216 acquires an audio A_{signal2} output from the return audio recording device 205 at the constant interval I_{audio} (step S211). The audio A_{signal2} is an audio acquired in the base R₁ at a time at which the audio presentation device 204 reproduces an audio A_{signal1} acquired at each time T_{audio} in the base O in the base R₁.

The return audio transmission unit 216 refers to the audio time management DB 232 and extracts a record having audio data including the acquired audio A_{signal2} (step S212). The audio A_{signal2} acquired by the return audio transmission unit 216 includes the audio A_{signal1} reproduced by the audio presentation device 204 and an audio generated at the base R₁ (cheers of the audience at the base R₁ and the like). In step S212, for example, the return audio transmission unit 216 separates the two audios by a known audio analysis technology. The return audio transmission unit 216 identifies the audio A_{signal1} reproduced by the audio presentation device 204 by separating the audios. The return audio transmission unit 216 refers to the audio time management DB 232 and searches for audio data that matches the identified audio A_{signal1} reproduced by the audio presentation device 204. The return audio transmission unit 216 refers to the audio time management DB 232 and extracts a record having the audio data that matches the identified audio A_{signal1} reproduced by the audio presentation device 204.

The return audio transmission unit 216 refers to the audio time management DB 232 and acquires a time T_{audio} in the audio synchronization reference time column of the extracted record (step S213).

The return audio transmission unit 216 generates an RTP packet that stores the audio A_{signal2} (step S214). In step S214, for example, the return audio transmission unit 216 stores the acquired audio A_{signal2} in an RTP packet. The return audio transmission unit 216 stores the acquired time T_{audio} in the header extension area of the RTP packet.

The return audio transmission unit 216 sends out the generated RTP packet that stores the audio A_{signal2} to the IP network (step S215).

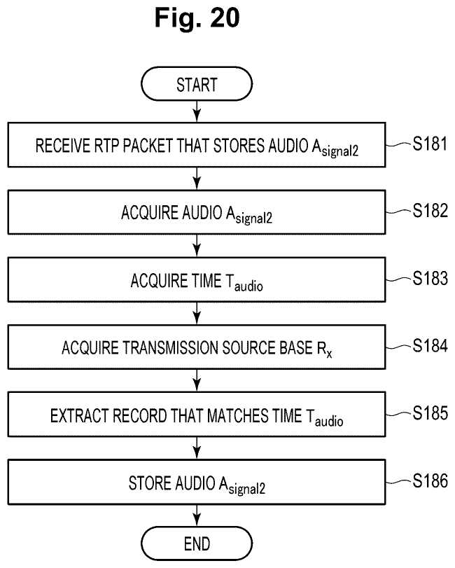

FIG. 20 is a flowchart illustrating a reception processing procedure and processing content of an RTP packet that stores an audio A_{signal2} of the server 1 in the base O according to the first embodiment. FIG. 20 illustrates the typical example of the processing of step S18 of the server 1.

The return audio reception unit 116 receives an RTP packet that stores an audio A_{signal2} sent out from the return audio transmission unit 216 via the IP network (step S181).

The return audio reception unit 116 acquires the audio A_{signal2} stored in the received RTP packet that stores the audio A_{signal2} (step S182).

The return audio reception unit 116 acquires a time T_{audio} stored in the header extension area of the received RTP packet that stores the audio A_{signal2} (step S183).

The return audio reception unit 116 acquires a transmission source base Rₓ from information stored in the header of the received RTP packet that stores the audio A_{signal2} (step S184).

The return audio reception unit 116 refers to the audio synchronization control DB 132 and extracts a record in which a time T_{audio} stored in the audio synchronization reference time column matches the time T_{audio} regarding the audio A_{signal2} acquired from the RTP packet that stores the audio A_{signal2} (step S185).

The return audio reception unit 116 stores the acquired audio A_{signal2} in the audio data x column regarding the acquired transmission source base Rₓ in the extracted record (step S186). Storing the audio A_{signal2} in a record of the audio synchronization control DB 132 is an example of storing the audio A_{signal2} in association with the time T_{audio}. For example, in a case where an RTP packet that stores an audio A_{signal2} is received from the server 2 in the base R₁, the return audio reception unit 116 stores the audio A_{signal2} in the audio data 1 column regarding the transmission source base R₁.

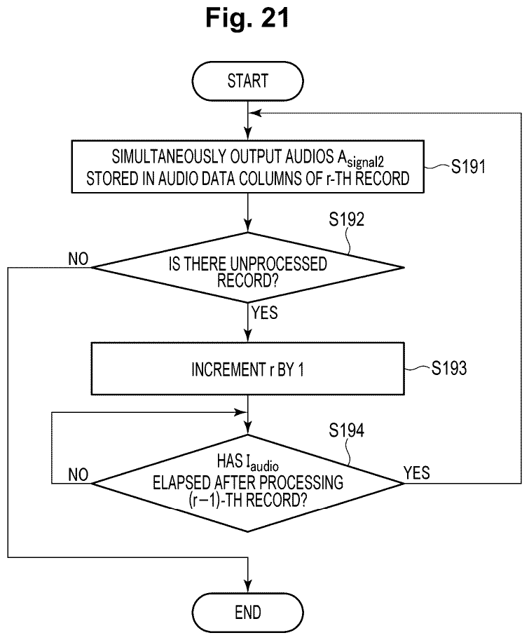

FIG. 21 is a flowchart illustrating a synchronization processing procedure and processing content of audios A_{signal2} of the server 1 in the base O according to the first embodiment. FIG. 21 illustrates the typical example of the processing of step S19 of the server 1.

The return audio synchronization control unit 117 simultaneously outputs all audios A_{signal2} stored in the n audio data columns of the r-th record in the audio synchronization control DB 132 to the return audio presentation device 104 (step S191). In step S191, for example, the return audio synchronization control unit 117 starts processing from the 0th record. The return audio synchronization control unit 117 starts outputting the audios A_{signal2} to the return audio presentation device 104 after a lapse of a time t_{audio} start from a start timing of sending out RTP packets that store audios A_{signal1} by the event audio transmission unit 115. For example, the time t_{audio_start} may be a time from the start timing of sending out the RTP packets that store the audios A_{signal1} by the event audio transmission unit 115 to when the audios A_{signal2} are stored in all the n audio data columns of the 0th record in the audio synchronization control DB 132. In this example, the time t_{audio_start} may be calculated by the return audio synchronization control unit 117. The time t_{audio_start} may be a predetermined value.

The return audio synchronization control unit 117 extracts one row from the r-th record. The return audio synchronization control unit 117 simultaneously outputs all audios A_{signal2} stored in the n audio data columns of the r-th record to the return audio presentation device 104. The r-th record is a record of one time T_{audio}. All the audios A_{signal2} stored in the n audio data columns of the r-th record are an example of audios A_{signal2} regarding a plurality of bases R among the bases R₁ to Rₙ associated with one time T_{audio}.

The r-th record may store audios A_{signal2} in all of the n audio data columns. In this example, audios A_{signal2} regarding all the bases R among the bases R₁ to Rₙ are stored in the r-th record. The return audio synchronization control unit 117 simultaneously outputs all audios A_{signal2} stored in all the n audio data columns of the r-th record to the return audio presentation device 104.

Audios A_{signal2} may be stored in a part of the n audio data columns in the r-th record. In this example, audios A_{signal2} regarding a plurality of the bases R that is a part of the bases R₁ to Rₙ are stored in the r-th record. The return audio synchronization control unit 117 simultaneously outputs all audios A_{signal2} stored in a plurality of audio data columns that is a part of the n audio data columns of the r-th record to the return audio presentation device 104. In an audio data column regarding a base R in which an audio A_{signal2} of the r-th record is not stored, the return audio synchronization control unit 117 may repeatedly output the audio A_{signal2} regarding the base R output to the return audio presentation device 104 in processing of the (r−1)-th record to the return audio presentation device 104. When r is 0, the return audio synchronization control unit 117 does not output an audio A_{signal2} to the return audio presentation device 104 in an audio data column regarding a base R in which an audio A_{signal2} of the 0th record is not stored.

The return audio synchronization control unit 117 determines whether there is an unprocessed record in the audio synchronization control DB 132 (step S192). In a case where there is no unprocessed record (NO in step S192), the processing ends. In a case where there is an unprocessed record (YES in step S192), the processing proceeds from step S192 to step S193.

The return audio synchronization control unit 117 increments the row number r by 1 (step S193).

The return audio synchronization control unit 117 determines whether the certain interval I_{audio} has elapsed after the processing the (r−1)-th record (step S194). In a case where the interval I_{audio} has not elapsed (NO in step S194), the return audio synchronization control unit 117 repeats the processing of step S194. In a case where the interval I_{audio} has elapsed (YES in step S194), the processing returns from step S194 to step S191.

As described above, the return audio synchronization control unit 117 extracts records row by row at constant intervals I_{audio} from the audio synchronization control DB 132. Every time a record is extracted, the return audio synchronization control unit 117 simultaneously outputs all audios A_{signal2} stored in the n audio data columns of the extracted record to the return audio presentation device 104. That is, even if there is an RTP packet that has not arrived at the base O by a reproduction time that is a processing time of the record, the return audio synchronization control unit 117 simultaneously outputs all audios A_{signal2} that have arrived at the base O by the reproduction time to the return audio presentation device 104. Even if an RTP packet arrives at the base O later than the reproduction time, the return audio synchronization control unit 117 does not output an audio A_{signal2} stored in the RTP packet to the return audio presentation device 104.

Note that a timing at which the server 1 simultaneously outputs all videos V_{signal2} of a record associated with a certain time T_{video} to the return video presentation device 102 and a timing at which the server 1 simultaneously outputs all audios A_{signal2} of a record associated with a time T_{audio} that matches the time T_{video} to the return audio presentation device 104 may be the same or different.

### (Effects)

As described above, in the first embodiment, the server 1 stores videos V_{signal2} in the video synchronization control DB 131 on the basis of times T_{video} stored in RTP packets that store the videos V_{signal2}. The server 1 simultaneously outputs videos V_{signal2} regarding a plurality of bases R associated with one time T_{video} stored in the video synchronization control DB 131 to the return video presentation device 102. The server 1 stores audios A_{signal2} in the audio synchronization control DB 132 on the basis of times T_{audio} stored in RTP packets that store the audios A_{signal2}. The server 1 simultaneously outputs audios A_{signal2} regarding a plurality of bases R associated with one time T_{audio} stored in the audio synchronization control DB 132 to the return audio presentation device 104.

As a result, the server 1 can associate videos V_{signal2} or audios A_{signal2} regarding the same acquisition time transmitted from a plurality of bases R at different timings with each other on the basis of acquisition times of videos V_{signal1} or audios A_{signal1}. The server 1 can simultaneously output videos V_{signal2} or audios A_{signal2} regarding a plurality of bases R associated with one acquisition time. The server 1 can appropriately synchronously reproduce a plurality of videos/audios that are returned and transmitted from a plurality of bases R through different transmission paths.

### Second Embodiment

A second embodiment is an embodiment in which time information for synchronously reproducing return videos/audios is stored in RTCP packets of an APP transmitted and received between a base O and bases R₁ to Rₙ, thereby synchronously reproducing the return videos/audios from the bases R₁ to Rₙ in the base O.

Although a video and an audio are described as being transmitted and received in RTP packetization, the present invention is not limited thereto. The video and audio may be processed and managed by the same functional unit/database (DB). Both the video and audio may be stored in one RTP packet and transmitted and received.

### (Configuration Example)

In the second embodiment, the same components as those of the first embodiment are denoted by the same reference signs, and description thereof will be omitted. In the second embodiment, differences from the first embodiment will be mainly described.

A hardware configuration of each electronic device included in a medium synchronization system S according to the second embodiment may be similar to that of the first embodiment, and description thereof will be omitted.

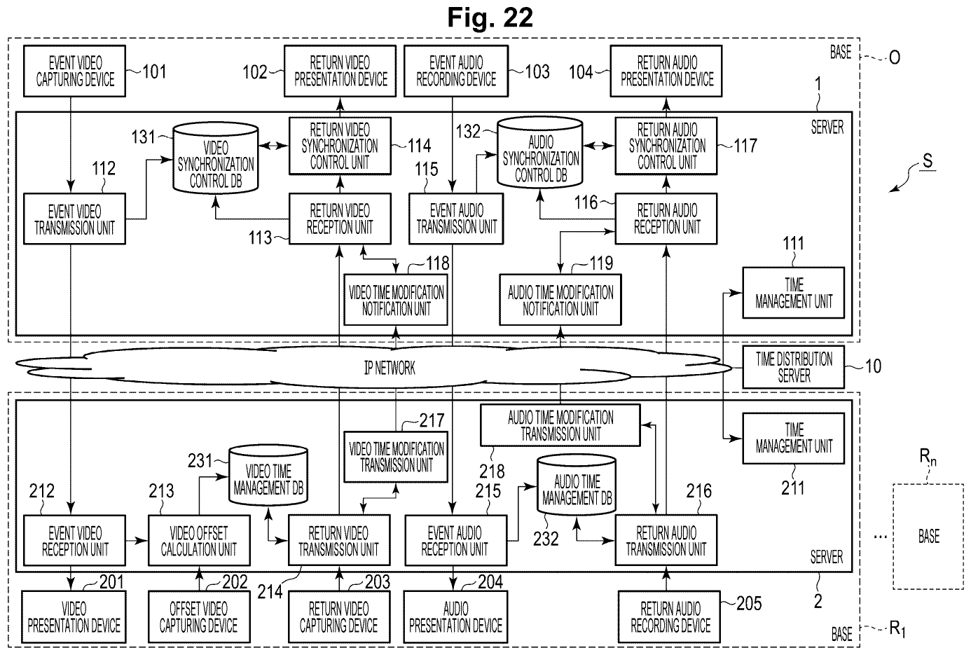

FIG. 22 is a block diagram illustrating an example of a software configuration of each electronic device included in the medium synchronization system S according to a second embodiment.

As in the first embodiment, a server 1 includes a time management unit 111, an event video transmission unit 112, a return video reception unit 113, a return video synchronization control unit 114, an event audio transmission unit 115, a return audio reception unit 116, a return audio synchronization control unit 117, a video synchronization control DB 131, and an audio synchronization control DB 132. Unlike the first embodiment, the server 1 includes a video time modification notification unit 118 and an audio time modification notification unit 119. Each functional unit is implemented by execution of a program by the control unit 11. It can also be said that each functional unit is included in the control unit 11 or the processor. Each functional unit can be read as the control unit 11 or the processor. The video synchronization control DB 131 and the audio synchronization control DB 132 are implemented by the data storage unit 13.

The video time modification notification unit 118 receives an RTCP packet that stores modified time information Δt_{video} from each of servers of bases R via an IP network. The modified time information Δt_{video} is a value of a difference between a time to and a time T_{video}. The time t₂ is an example of an acquisition time of a video V_{signal2} acquired in a base R at a time at which a video V_{signal1} acquired at a time T_{video} in the base O is reproduced in the base R. The RTCP packet is an example of a packet. The RTCP packet that stores the modified time information Δt_{video} is an example of a third packet. The video time modification notification unit 118 is an example of a second reception unit.

The audio time modification notification unit 119 receives an RTCP packet that stores modified time information Δt_{audio} from each of the servers of the bases R via an IP network. The modified time information Δt_{audio} is a value of a difference between a time t₃ and a time T_{audio}. The time t₃ is an example of an acquisition time of an audio A_{signal2} acquired in a base R at a time at which an audio A_{signal1} acquired at a time T_{audio} in the base O is reproduced in the base R. The RTCP packet that stores the modified time information Δt_{audio} is an example of the third packet. The audio time modification notification unit 119 is an example of a second reception unit.

As in the first embodiment, a server 2 includes a time management unit 211, an event video reception unit 212, a video offset calculation unit 213, a return video transmission unit 214, an event audio reception unit 215, a return audio transmission unit 216, a video time management DB 231, and an audio time management DB 232. Unlike the first embodiment, the server 2 includes a video time modification transmission unit 217 and an audio time modification transmission unit 218. Each functional unit is implemented by execution of a program by the control unit 21. It can also be said that each functional unit is included in the control unit 21 or a processor. Each functional unit can be read as the control unit 21 or the processor. The video time management DB 231 and the audio time management DB 232 are implemented by the data storage unit 23.

The video time modification transmission unit 217 transmits an RTCP packet that stores modified time information Δt_{video} to the server 1 via an IP network.

The audio time modification transmission unit 218 transmits an RTCP packet that stores modified time information Δt_{audio} to the server 1 via an IP network.

### (Operation Example)

Hereinafter, operation of the base O and the base R₁ will be described as an example. Operation of the bases R₂ to Rₙ may be similar to operation of the base R₁, and description thereof will be omitted. The notation of the base R₁ may be read as the bases R₂ to Rₙ.

### (1) Synchronize and Reproduce Return Videos

Video processing of the server 1 in the base O will be described.

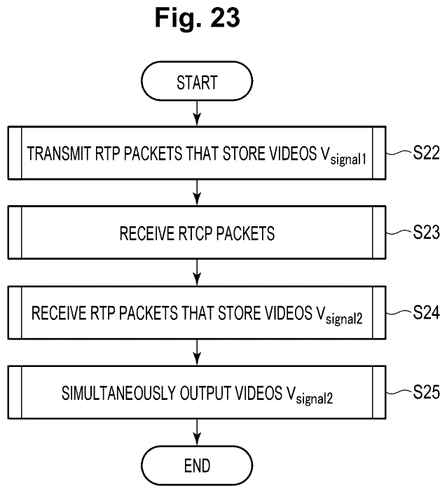

FIG. 23 is a flowchart illustrating a video processing procedure and processing content of the server 1 in the base O according to the second embodiment.

The event video transmission unit 112 transmits an RTP packet that stores a video V_{signal1} to each of the servers of the bases R via the IP network (step S22).

A typical example of the processing of the event video transmission unit 112 in step S22 may be similar to the processing described in the first embodiment using FIG. 9, and description thereof will be omitted. Note that the event video transmission unit 112 may store a time T_{video} in an RTP time stamp of the RTP packet instead of the header extension area of the RTP packet.

The video time modification notification unit 118 receives an RTCP packet that stores modified time information Δt_{video} from each of servers of bases R via an IP network (step S23). A typical example of processing of step S23 will be described below.

The return video reception unit 113 receives an RTP packet that stores a video V_{signal2} from each of the servers of the bases R via the IP network (step S24). The return video reception unit 113 stores videos V_{signal2} in the video synchronization control DB 131 on the basis of times obtained by subtracting modified time information Δt_{video} from times T′ stored in RTP packets that store the videos V_{signal2}. A time T′ is an example of an acquisition time of a video V_{signal2} acquired in a base R at a time at which a video V_{signal1} acquired at a time T_{video} in the base O is reproduced in the base R. A typical example of processing of step S24 will be described below.

The return video synchronization control unit 114 simultaneously outputs videos V_{signal2} regarding a plurality of bases R among the bases R₁ to Rₙ associated with one time T_{video} stored in the video synchronization control DB 131 to the return video presentation device 102 (step S25).

A typical example of the processing of the return video synchronization control unit 114 in step S25 may be similar to the processing described in the first embodiment using FIG. 14, and description thereof will be omitted.

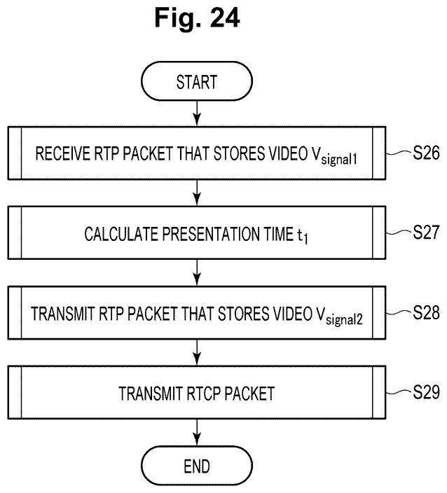

FIG. 24 is a flowchart illustrating a video processing procedure and processing content of the server 2 in the base R₁ according to the second embodiment.

The event video reception unit 212 receives an RTP packet that stores a video V_{signal1} from the server 1 via the IP network (step S26).

A typical example of the processing of the event video reception unit 212 in step S26 may be similar to the processing described in the first embodiment using FIG. 10, and description thereof will be omitted. Note that the event video reception unit 212 may acquire a time T_{video} stored in an RTP time stamp of the RTP packet instead of the header extension area of the RTP packet.

The video offset calculation unit 213 calculates a presentation time t₁ at which the video V_{signal1} is reproduced by the video presentation device 201 (step S27).

A typical example of the processing of the video offset calculation unit 213 in step S27 may be similar to the processing described in the first embodiment using FIG. 11, and description thereof will be omitted.

The return video transmission unit 214 transmits an RTP packet that stores a video V_{signal2} to the server 1 via the IP network (step S28). A typical example of processing of step S28 will be described below.

The video time modification transmission unit 217 transmits an RTCP packet that stores modified time information Δt_{video} to the server 1 via an IP network (step S29). A typical example of processing of step S29 will be described below.

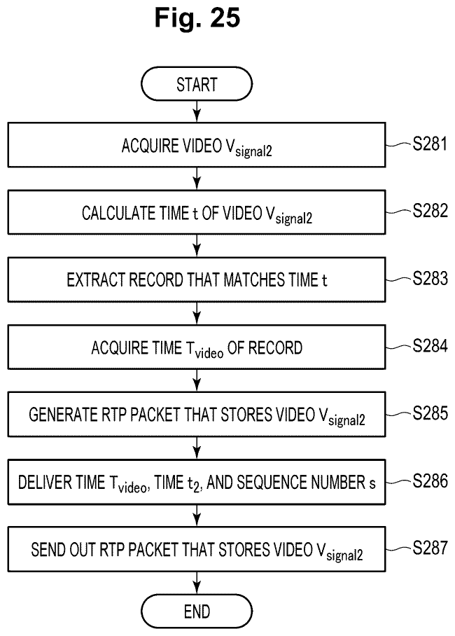

FIG. 25 is a flowchart illustrating a transmission processing procedure and processing content of an RTP packet that stores a video V_{signal2} of the server 2 in the base R₁ according to the second embodiment. FIG. 25 illustrates the typical example of the processing of step S28 of the server 2.

The return video transmission unit 214 acquires a video V_{signal2} output from the return video capturing device 203 at constant intervals I_{video} (step S281). The video V_{signal2} is a video acquired in the base R₁ at a time at which the video presentation device 201 reproduces a video V_{signal1} acquired at each time T_{video} in the base O in the base R₁. The return video transmission unit 214 acquires a time the that is an absolute time at which the video V_{signal2} obtained by capturing by the return video capturing device 203 is sampled. Note that the time t₂ is a time obtained by adding Δ (minimum) to a time t that is an absolute time at which the video V_{signal2} is obtained by capturing. A is a time from when a video (one still image) is obtained by capturing until the video is transmitted from the return video capturing device 203 to the return video transmission unit 214 and conversion processing from an analog signal to a digital signal by the return video transmission unit 214 is started. Since Δ is a value infinitely close to 0, the time t₂ may be regarded as the same as the time t.

The return video transmission unit 214 calculates the time t that is an absolute time at which the acquired video V_{signal2} is obtained by capturing (step S282). In step S282, for example, in a case where a time code T_{c} (absolute time) representing a capturing time is provided to the video V_{signal2}, the return video transmission unit 214 acquires the time t as t=T_{c}. In a case where the time code T_{c} is not provided to the video V_{signal2}, the return video transmission unit 214 acquires a current time Tₙ from the reference system clock managed by the time management unit 211. The return video transmission unit 214 acquires the time t as t=Tₙ−t_{video_offset} using a predetermined value t_{video_offset} (positive number).

The return video transmission unit 214 refers to the video time management DB 231 and extracts a record having a time t₁ that matches the acquired time t (step S283).

The return video transmission unit 214 refers to the video time management DB 231 and acquires a time T_{video} in the video synchronization reference time column of the extracted record (step S284).

The return video transmission unit 214 generates an RTP packet that stores the video V_{signal2} (step S285). In step S285, for example, the return video transmission unit 214 stores the acquired video V_{signal2} in an RTP packet. In step S285, the return video transmission unit 214 stores a time T′ corresponding to the time t₂ in an RTP time stamp of the RTP packet. The time T′ is the earliest time ta in a set of times t₂ regarding videos V_{signal2} stored in RTP packets. The time T′ may be regarded as the same as the time t. The RTP packet that stores the video V_{signal2} includes a sequence number s of the RTP packet header. For simplification of the processing flow, the sequence number s does not return to 0 and is continuously incremented for each generated RTP packet.

The return video transmission unit 214 delivers the acquired time T_{video}, time t₂, and sequence number s to the video time modification transmission unit 217 (step S286).

The return video transmission unit 214 sends out the generated RTP packet that stores the video V_{signal2} to the IP network (step S287).

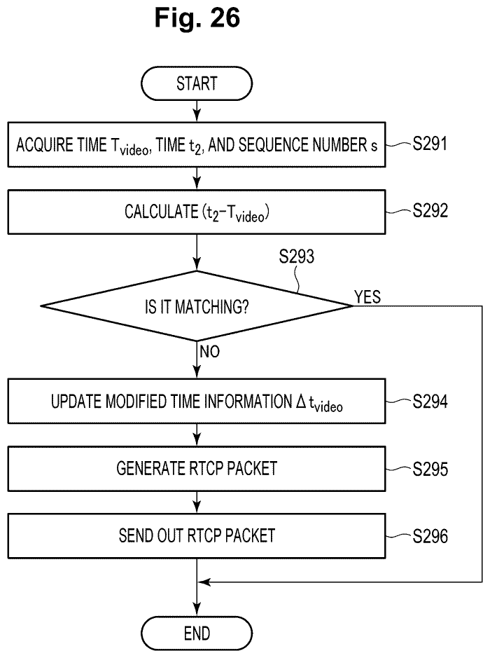

FIG. 26 is a flowchart illustrating a transmission processing procedure and processing content of an RTCP packet that stores modified time information Δt_{video} of the server 2 in the base R₁ according to the second embodiment. FIG. 26 illustrates the typical example of the processing of step S29 of the server 2.

The video time modification transmission unit 217 acquires a time T_{video}, a time t₂, and a sequence number s from the return video transmission unit 214 (step S291).

The video time modification transmission unit 217 calculates a time (t₂−T_{video}) obtained by subtracting the time T_{video} from the time t₂ on the basis of the time T_{video} and the time t₂ (step S292).

The video time modification transmission unit 217 determines whether the time (t₂−T_{video}) matches current modified time information Δt_{video} (step S293). The modified time information Δt_{video} is a value of a difference between a time t₂ and a time T_{video}. The current modified time information Δt_{video} is a value of a time (t₂−T_{video}) calculated before the time (t₂−T_{video}) calculated this time. An initial value of the modified time information Δt_{video} is set to 0. In a case where the time (t₂−T_{video}) matches the current modified time information Δt_{video} (YES in step S293), the processing ends. In a case where the time (t₂−T_{video}) does not match the current modified time information Δt_{video} (NO in step S293), the processing proceeds from step S293 to step S294. The time (t₂−T_{video}) not matching the current modified time information Δt_{video} corresponds to the modified time information Δt_{video} having changed.

The video time modification transmission unit 217 updates the Δt_{video} to Δt_{video}=t₂−T_{video} (step S294).

The video time modification transmission unit 217 generates an RTCP packet that stores the modified time information Δt_{video} (step S295). In step S295, for example, the video time modification transmission unit 217 describes the updated modified time information Δt_{video} using an APP in the RTCP. The video time modification transmission unit 217 generates an RTCP packet that stores the modified time information Δt_{video}. The video time modification transmission unit 217 describes a sequence number s regarding the updated modified time information Δt_{video} by using the APP in an RTCP. The RTCP packet that stores the modified time information Δt_{video} stores the sequence number s.

The video time modification transmission unit 217 sends out the generated RTCP packet that stores the modified time information Δt_{video} to the IP network (step S296). Note that the video time modification transmission unit 217 starts the processing illustrated in FIG. 26 before the return video transmission unit 214 sends out an RTP packet that stores a video V_{signal2}. Therefore, it is assumed that a timing at which the video time modification transmission unit 217 sends out the RTCP packet that stores the modified time information Δt_{video} is temporally earlier than a timing at which the return video transmission unit 214 sends out an RTP packet that stores a video V_{signal2}.

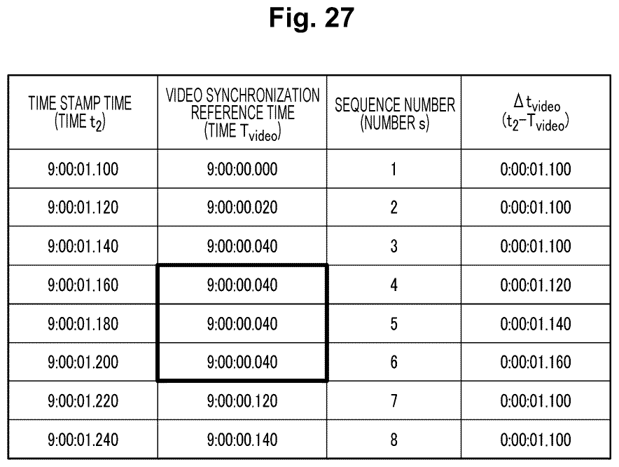

FIG. 27 is a diagram illustrating a processing example by the video time modification transmission unit 217 of the server 2 in the base R₁ according to the second embodiment.

FIG. 27 illustrates times T_{video}, times t₂, and sequence numbers s that the video time modification transmission unit 217 acquires from the return video transmission unit 214, and times (t₂−T_{video}) calculated by the video time modification transmission unit 217 in association with each other.

A time ta is a time at a constant interval corresponding to the sequence number s. A time T_{video} associated with a sequence number s=4 to 6 is not a time of a constant interval I_{video}. This is because a packet loss occurs at the time of transmission from the base o to the base R. A time (t₂−T_{video}) associated with a sequence number s=4 to 7 is changed from a time associated with the previous sequence number s.

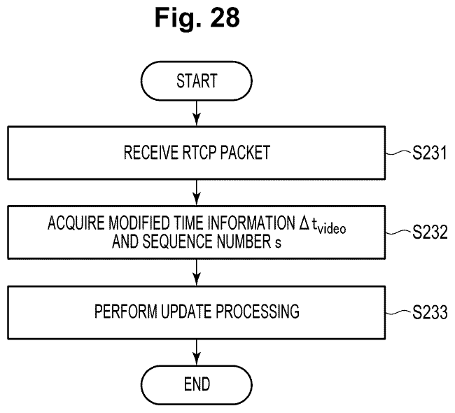

FIG. 28 is a flowchart illustrating a reception processing procedure and processing content of an RTCP packet that stores modified time information Δt_{video} of the server 1 in the base O according to the second embodiment. FIG. 28 illustrates the typical example of the processing of step S23 of the server 1.

The video time modification notification unit 118 receives an RTCP packet that stores modified time information Δt_{video} from each of the servers of the bases R via an IP network (step S231). As described above, the video time modification transmission unit 217 transmits an RTCP packet that stores modified time information Δt_{video} to the server 1 on the basis of change of the modified time information Δt_{video}. Therefore, the video time modification notification unit 118 receives an RTCP packet that stores modified time information Δt_{video} on the basis of change of the modified time information Δt_{video} by each of the servers of the bases R.

The video time modification notification unit 118 acquires the modified time information Δt_{video} and a sequence number s stored in the RTCP packet that stores the modified time information Δt_{video} (step $232).

The video time modification notification unit 118 performs update processing on (s_{video_old}, Δt_{video_old}) and (s_{video_new}, Δt_{video_new}) on the basis of the acquired modified time information Δt_{video} and sequence number s (step S233). The s_{video_old} and the s_{video_new} are values based on the acquisition history of the sequence number s. The Δt_{video_old} and the Δt_{video_new} are values based on the acquisition history of the modified time information Δt_{video}. Initial values of respective variables are set as s_{video_old}=0, s_{video_new}=0, Δt_{video_new}=0, Δt_{video_old}=0. In step S233, for example, the video time modification notification unit 118 updates the (s_{video_old}, Δt_{video_old}) and the (s_{video_new}, Δt_{video_new}) as follows.
When (s−s_{video_new}≠1),
s_{video_old}=s−s_{video_new}, Δt_{video_old}=Δt_{video_new}
s_{video_new}=s, Δt_{video_new}=Δt_{video}
When (s−s_{video_new}=1),
   When Δt_{video}>Δt_{video_new},
      s_{video_oid}=s_{video_old} (not updated), Δt_{video_old}=Δt_{video_new}
      s_{video_new}=s, Δt_{video_new}=Δt_{video}
   When Δt_{video}<Δt_{video_new},
      s_{video_old}=s_{video_new}, Δt_{video_old}=Δt_{video_new}
      s_{video_new}=s, Δt_{video_new}=Δt_{video}

As described above, the video time modification notification unit 118 sets the Δt_{video_new} before the update processing to the Δt_{video_old}. The video time modification notification unit 118 changes the update mode of the s_{video_old} on the basis of the comparison result between the sequence number s and the s_{video_new} and the comparison result between the modified time information Δt_{video} and the Δt_{video_new}. The video time modification notification unit 118 sets the acquired sequence number s and modified time information Δt_{video} to the (s_{video_new}, Δt_{video_new}).

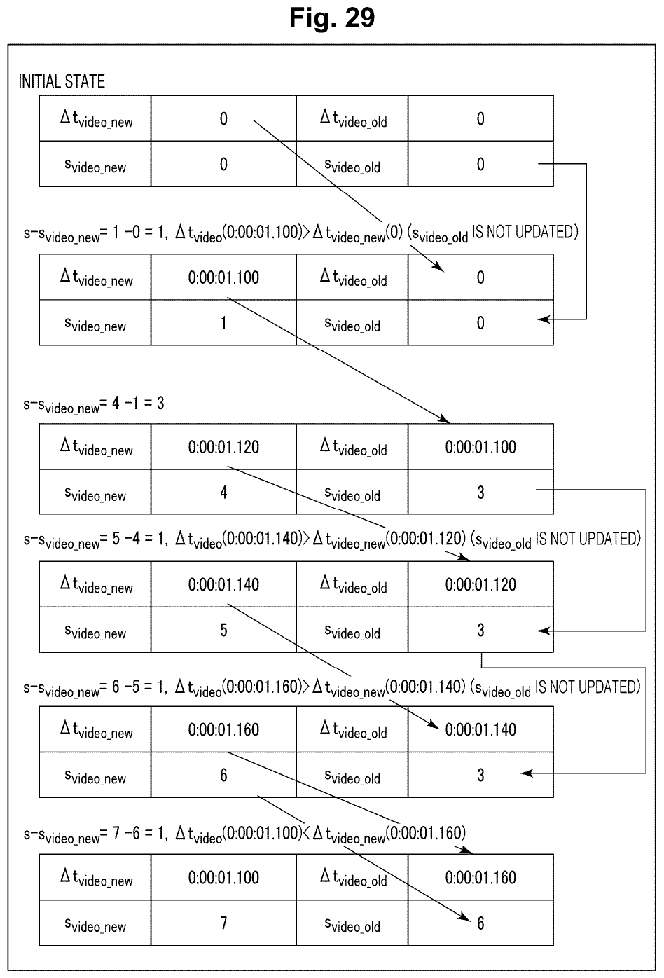

FIG. 29 is a diagram illustrating a processing example by the video time modification notification unit 118 of the server 1 in a base R according to the second embodiment.

Initial states of (s_{video_old}, Δt_{video_old}) and (s_{video_new}, Δt_{video_new}) are (s_{video_old}, Δt_{video_old})=(0, 0) and (s_{video_new}, Δt_{video_new})=(0, 0).

It is assumed that the video time modification notification unit 118 obtains (s, Δt_{video})=(1, 0:00:01.100). (s−s_{video_new}) is 1−0=1. Δt_{video} (0:00:01.100)>Δt_{video_new} (0) The video time modification notification unit 118 does not update the s_{video_old}. The video time modification notification unit 118 sets the Δt_{video_new} (0) before the update processing to the Δt_{video_old}. The video time modification notification unit 118 sets the acquired sequence number s (1) to the s_{video_new}. The video time modification notification unit 118 sets the acquired Δt_{video} (0:00:01.100) to the Δt_{video_new}.

Next, it is assumed that the video time modification notification unit 118 obtains (s, Δt_{video})=(4, 0:00:01.120). (s−s_{video_new}) is 4−1=3. The video time modification notification unit 118 sets (s−s_{video_new})=(3) to the s_{video_old}. The video time modification notification unit 118 sets the Δt_{video_new} (0:00:01.100) before the update processing to the Δt_{video_old}. The video time modification notification unit 118 sets the acquired sequence number s (4) to the s_{video_new}. The video time modification notification unit 118 sets the acquired Δt_{video} (0:00:01.120) to the Δt_{video_new}.

Next, it is assumed that the video time modification notification unit 118 obtains (s, Δt_{video})=(5, 0:00:01.140). (s−s_{video_new}) is 5−4=1. Δt_{video} (0:00:01.140)>Δt_{video_new} (0:00:01.120) The video time modification notification unit 118 does not update the s_{video_old}. The video time modification notification unit 118 sets the Δt_{video_new} (0:00:01.120) before the update processing to the Δt_{video_old}. The video time modification notification unit 118 sets the acquired sequence number s (5) to the s_{video_new}. The video time modification notification unit 118 sets the acquired Δt_{video} (0:00:01.140) to the Δt_{video_new}.

Next, it is assumed that the video time modification notification unit 118 obtains (s, Δt_{video})=(6, 0:00:01.160). (s−s_{video_new}) is 6−5=1. Δt_{video} (0:00:01.160)>Δt_{video_new} (0:00:01.140) The video time modification notification unit 118 does not update the s_{video_old}. The video time modification notification unit 118 sets the Δt_{video_new} (0:00:01.140) before the update processing to the Δt_{video_old}. The video time modification notification unit 118 sets the acquired sequence number s (6) to the s_{video_new}. The video time modification notification unit 118 sets the acquired Δt_{video} (0:00:01.160) to the Δt_{video_new}.

It is assumed that the video time modification notification unit 118 obtains (s, Δt_{video})=(7, 0:00:01.100). (s−s_{video_new}) is 7−6=1. Δt_{video} (0:00:01.100)<Δt_{video_new} (0:00:01.160) The video time modification notification unit 118 sets the s_{video_new} (6) before the update processing to the s_{video_old}. The video time modification notification unit 118 sets the Δt_{video_new} (0:00:01.160) before the update processing to the Δt_{video_old}. The video time modification notification unit 118 sets the acquired sequence number s (7) to the s_{video_new}. The video time modification notification unit 118 sets the acquired Δt_{video} (0:00:01.100) to the Δt_{video_new}.

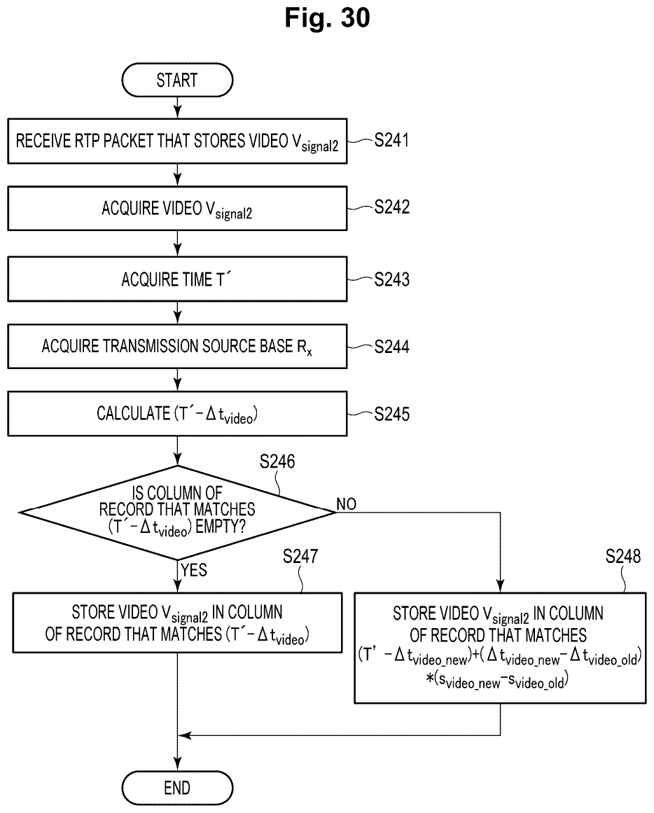

FIG. 30 is a flowchart illustrating a reception processing procedure and processing content of an RTP packet that stores a video V_{signal2} of the server 1 in the base O according to the second embodiment. FIG. 30 illustrates the typical example of the processing of step S24 of the server 1.

The return video reception unit 113 receives an RTP packet that stores a video V_{signal2} sent out from the return video transmission unit 214 via the IP network (step S241).

The return video reception unit 113 acquires the video V_{signal2} stored in the received RTP packet that stores the video V_{signal2} (step S242).

The return video reception unit 113 acquires a time T′ stored in an RTP time stamp of the received RTP packet that stores the video V_{signal2} (step S243).

The return video reception unit 113 acquires a transmission source base Rₓ (x is any one of 1, 2, . . . , and n) from information stored in the header of the received RTP packet that stores the video V_{signal2} (step S244).

The return video reception unit 113 calculates a time (T′−Δt_{video}) obtained by subtracting a modified time information Δt_{video} from a time T′ on the basis of the time T′ and the modified time information Δt_{video} (step S245).

The return video reception unit 113 refers to the video synchronization control DB 131 and determines whether a video data x column regarding the acquired transmission source base R, is empty in a record in which a time T_{video} matches the time (T′−Δt_{video}) (step S246). In a case where the video data x column regarding the transmission source base Rₓ is empty (YES in step S246), the processing proceeds from step S246 to step S247. In a case where the video data x column regarding the transmission source base Rₓ is not empty (NO in step S246), the processing proceeds from step S246 to step S248.

The return video reception unit 113 refers to the video synchronization control DB 131 and stores the video V_{signal2} in the video data x column regarding the transmission source base Rₓ in a record in which the time T_{video} matches the time (T′−Δt_{video}) (step S247). The processing in step S247 is an example of storing the video V_{signal2} in the video synchronization control DB 131 in association with the time T_{video} regarding the video V_{signal2} on the basis of the time (T′−Δt_{video}).

The return video reception unit 113 refers to the video synchronization control DB 131 and stores the video V_{signal2} in the video data x column regarding the transmission source base Rₓ in a record in which the time T_{video} matches a time {(T′−Δt_{video_new})+(Δt_{video_new}−Δt_{video_old)}*(s_{video_new}−s_{video_old})} (step S248). The processing in step S248 is an example of storing the video V_{signal2} in the video synchronization control DB 131 in association with the time T_{video} regarding the video V_{signal2} on the basis of the time (T′−Δt_{video}). Being based on the time (T′−Δt_{video}) includes being based on the time {(T′−Δt_{video_new})+(Δt_{video}_new−Δt_{video_old})*(s_{video_new}−s_{video_old})} obtained by adding a modified time according to the acquisition history of the modified time information Δt_{video} and the sequence number s to the time (T′−Δt_{video}).

### (2) Synchronize and Reproduce Return Audios

Audio processing of the server 1 in the base O will be described.

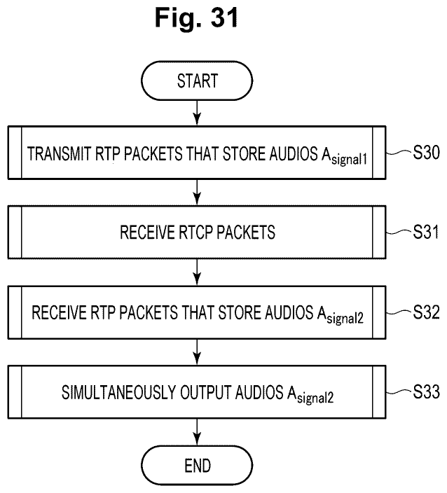

FIG. 31 is a flowchart illustrating an audio processing procedure and processing content of the server 1 in the base O according to the second embodiment.

The event audio transmission unit 115 transmits an RTP packet that stores an audio A_{signal1} to each of the servers of the bases R via the IP network (step S30).

A typical example of the processing of the event audio transmission unit 115 in step S30 may be similar to the processing described in the first embodiment using FIG. 17, and description thereof will be omitted. Note that the event audio transmission unit 115 may store a time T_{audio} in an RTP time stamp of the RTP packet instead of the header extension area of the RTP packet.

The audio time modification notification unit 119 receives an RTCP packet that stores modified time information Δt_{audio} from each of the servers of the bases R via an IP network (step S31). A typical example of processing of step S31 will be described below.

The return audio reception unit 116 receives an RTP packet that stores an audio A_{signal2} from each of the servers of the bases R via the IP network (step S32). The return audio reception unit 116 stores audios A_{signal2} in the audio synchronization control DB 132 on the basis of times obtained by subtracting modified time information Δt_{audio} from times T′ stored in RTP packets that store the audios A_{signal2}. A time T′ is an example of an acquisition time of an audio A_{signal2} acquired in a base R at a time at which an audio A_{signal1} acquired at a time T_{audio} in the base O is reproduced in the base R. A typical example of processing of step S32 will be described below.

The return audio synchronization control unit 117 simultaneously outputs audios A_{signal1} regarding a plurality of bases R among the bases R₁ to Rₙ associated with one time T_{audio} stored in the audio synchronization control DB 132 to the return audio presentation device 104 (step S33).

A typical example of the processing of the return audio synchronization control unit 117 in step S33 may be similar to the processing described in the first embodiment using FIG. 21, and description thereof will be omitted.

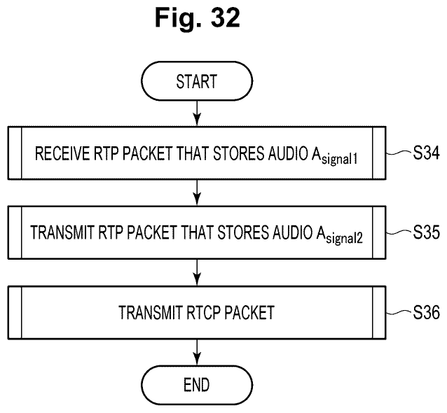

FIG. 32 is a flowchart illustrating an audio processing procedure and processing content of the server 2 in the base R₁ according to the second embodiment.

The event audio reception unit 215 receives an RTP packet that stores an audio A_{signal1} from the server 1 via the IP network (step S34).

A typical example of the processing of the event audio reception unit 215 in step S34 may be similar to the processing described in the first embodiment using FIG. 18, and description thereof will be omitted. Note that the event audio reception unit 215 may acquire a time T_{audio} stored in an RTP time stamp of the RTP packet instead of the header extension area of the RTP packet.

The return audio transmission unit 216 transmits an RTP packet that stores an audio A_{signal2} to the server 1 via the IP network (step S35). A typical example of processing of step S35 will be described below.

The audio time modification transmission unit 219 transmits an RTCP packet that stores modified time information Δt_{audio} to the server 1 via an IP network (step S36). A typical example of processing of step S36 will be described below.

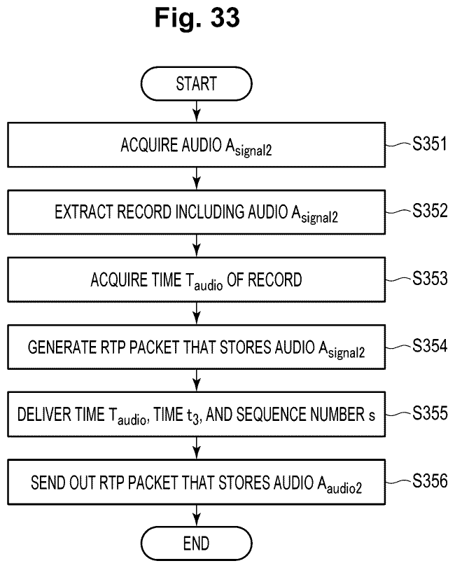

FIG. 33 is a flowchart illustrating a transmission processing procedure and processing content of an RTP packet that stores an audio A_{signal2} of the server 2 in the base R₁ according to the second embodiment. FIG. 33 illustrates the typical example of the processing of step S35 of the server 2.

The return audio transmission unit 216 acquires an audio A_{signal2} output from the return audio recording device 205 at the constant interval I_{audio} (step S351). The audio A_{signal2} is an audio acquired in the base R₁ at a time at which the audio presentation device 204 reproduces an audio A_{signal1} acquired at each time T_{audio} in the base O in the base R₁. The return audio transmission unit 216 acquires a time t₃ that is an absolute time at which the audio A_{signal2} obtained by recording by the return audio recording device 205 is sampled. Note that the time ta is a time obtained by adding Δ (minimum) to the absolute time at which the audio A_{signal2} is obtained by recorded. A is a time from when the audio A_{signal2} is obtained by recording until the audio A_{signal2} is transmitted from the return audio recording device 205 to the return audio transmission unit 216 and conversion processing from an analog signal to a digital signal by the return audio transmission unit 216 is started. Since Δ is a value infinitely close to 0, the time t₃ may be regarded as the same as the absolute time at which the audio A_{signal2} is obtained by recording.

The return audio transmission unit 216 refers to the audio time management DB 232 and extracts a record having audio data including the acquired audio A_{signal2} (step S352). The audio A_{signal2} acquired by the return audio transmission unit 216 includes the audio A_{signal1} reproduced by the audio presentation device 204 and an audio generated at the base R₁ (cheers of the audience at the base R₁ and the like). In step S352, for example, the return audio transmission unit 216 separates the two audios by a known audio analysis technology. The return audio transmission unit 216 identifies the audio A_{signal1} reproduced by the audio presentation device 204 by separating the audios. The return audio transmission unit 216 refers to the audio time management DB 232 and searches for audio data that matches the identified audio A_{signal1} reproduced by the audio presentation device 204. The return audio transmission unit 216 refers to the audio time management DB 232 and extracts a record having the audio data that matches the identified audio A_{signal1} reproduced by the audio presentation device 204.

The return audio transmission unit 216 refers to the audio time management DB 232 and acquires a time T_{audio} in the audio synchronization reference time column of the extracted record (step S353).

The return audio transmission unit 216 generates an RTP packet that stores the audio A_{signal2} (step S354). In step S354, for example, the return audio transmission unit 216 stores the acquired audio A_{signal2} in an RTP packet. In step S354, the return audio transmission unit 216 stores a time T′ corresponding to the time t₃ in an RTP time stamp of the RTP packet. The time T′ is the earliest time t₃ in a set of times t₃ regarding audios A_{signal2} stored in RTP packets. The time T′ may be regarded as the same as the absolute time at which the audio A_{signal2} is obtained by recording. The RTP packet that stores the audio A_{signal2} includes a sequence number s of the RTP packet header. For simplification of the processing flow, the sequence number s does not return to 0 and is continuously incremented for each generated RTP packet.

The return audio transmission unit 216 delivers the acquired time T_{audio}, time t₃, and sequence number s to the audio time modification transmission unit 218 (step S355). The return audio transmission unit 216 sends out the generated RTP packet that stores the audio A_{signal2} to the IP network (step S356).

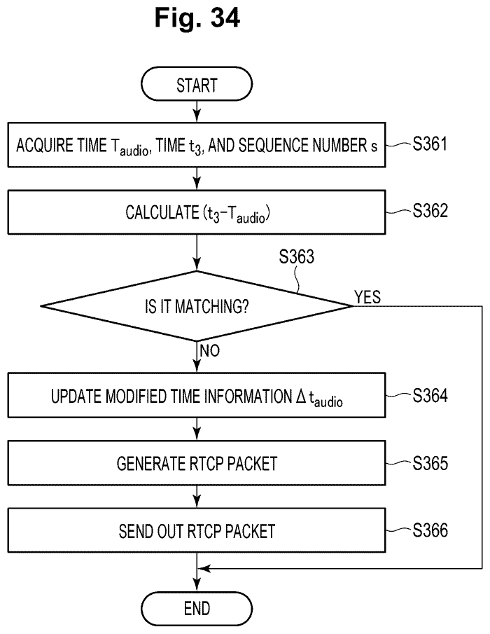

FIG. 34 is a flowchart illustrating a transmission processing procedure and processing content of an RTCP packet that stores modified time information Δt_{audio} of the server 2 in the base R₁ according to the second embodiment. FIG. 34 illustrates the typical example of the processing of step S36 of the server 2.

The audio time modification transmission unit 218 acquires a time T_{audio}, a time t₃, and a sequence number s from the return audio transmission unit 216 (step S361).

The audio time modification transmission unit 218 calculates a time (t₃−T_{audio}) obtained by subtracting the time T_{audio} from the time t₃ on the basis of the time T_{audio} and the time t₃ (step S362).

The audio time modification transmission unit 218 determines whether the time (t₃−T_{audio}) matches current modified time information Δt_{audio} (step S363). The modified time information Δt_{audio} is a value of a difference between a time t₃ and a time T_{audio}. The current modified time information Δt_{audio} is a value of a time (t₃−T_{audio}) calculated before the time (t₃−T_{audio}) calculated this time. An initial value of the modified time information Δt_{audio} is set to 0. In a case where the time (t₃−T_{audio}) matches the current modified time information Δt_{audio} (YES in step S363), the processing ends. In a case where the time (t₃−T_{audio}) does not match the current modified time information Δt_{audio} (NO in step S363), the processing proceeds from step S363 to step S364. The time (t₃−T_{audio}) not matching the current modified time information Δt_{audio} corresponds to the modified time information Δt_{audio} having changed.

The audio time modification transmission unit 218 updates the Δt_{audio} to Δt_{audio}=t₃−T_{audio} (step S364).

The audio time modification transmission unit 218 generates an RTCP packet that stores the modified time information Δt_{audio} (step S365). In step S365, for example, the audio time modification transmission unit 218 describes the updated modified time information Δt_{audio} using an APP in the RTCP. The audio time modification transmission unit 218 generates an RTCP packet that stores the modified time information Δt_{audio}. The audio time modification transmission unit 218 describes a sequence number s regarding the updated modified time information Δt_{audio} by using the APP in an RTCP. The RTCP packet that stores the modified time information Δt_{audio} stores the sequence number S.

The audio time modification transmission unit 218 sends out the generated RTCP packet that stores the modified time information Δt_{audio} to the IP network (step S366). Note that the audio time modification transmission unit 218 starts the processing illustrated in FIG. 34 before the return audio transmission unit 216 sends out an RTP packet that stores an audio A_{signal2}. Therefore, it is assumed that a timing at which the audio time modification transmission unit 218 sends out the RTCP packet that stores the modified time information Δt_{audio} is temporally earlier than a timing at which the return audio transmission unit 216 sends out an RTP packet that stores an audio A_{signal2}.

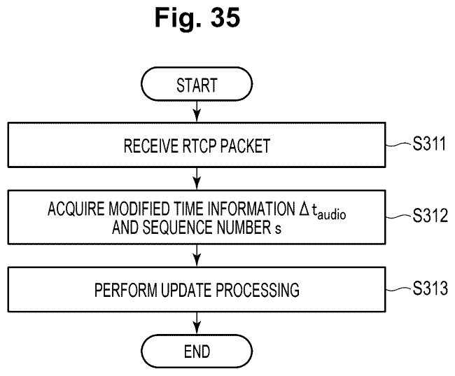

FIG. 35 is a flowchart illustrating a reception processing procedure and processing content of the RTCP packet that stores the modified time information Δt_{audio} of the server 1 in the base O according to the second embodiment. FIG. 35 illustrates the typical example of the processing of step S31 of the server 1.

The audio time modification notification unit 119 receives an RTCP packet that stores modified time information Δt_{audio} from each of the servers of the bases R via an IP network (step S311). As described above, the audio time modification transmission unit 218 transmits an RTCP packet that stores modified time information Δt_{audio} to the server 1 on the basis of change of the modified time information Δt_{audio}. Therefore, the video time modification notification unit 118 receives an RTCP packet that stores modified time information Δt_{audio} on the basis of change of the modified time information Δt_{audio} by each of the servers of the bases R.

The audio time modification notification unit 119 acquires the modified time information Δt_{audio} and a sequence number s stored in the RTCP packet that stores the modified time information Δt_{audio} (step S312).

The audio time modification notification unit 119 performs update processing on (s_{audio_old}, Δt_{audio_old}) and (s_{audio_new}, Δt_{audio_new}) on the basis of the acquired modified time information Δt_{audio} and sequence number s (step S313). The s_{audio_old} and the s_{audio_new} are values based on the acquisition history of the sequence number s. The Δt_{audio_old} and the Δt_{audio} new are values based on the acquisition history of the modified time information Δt_{audio}. Initial values of respective variables are set as s_{audio_old}=0, s_{audio_new}=0, Δt_{audio_new}=0, Δt_{audio_old}=0. In step S313, for example, the audio time modification notification unit 119 updates the (s_{audio_old}, Δt_{audio_old}) and the (s_{audio_new}, Δt_{audio_new}) as follows.
When (s−s_{audio_new}≠1),
s_{audio_old}=s−s_{audio_new}, Δt_{audio_old}=Δt_{audio_new}
s_{audio_new}=s, Δt_{audio_new}=Δt_{audio}
When (s−s_{audio_new}=1),
   When Δt_{audio}>Δt_{audio_new},
      s_{audio_old}=s_{audio_old} (not updated), Δt_{audio_old}=Δt_{audio_new}
      s_{audio_new}=s, Δt_{audio_new}=Δt_{audio}
   When Δt_{audio}<Δt_{audio_new},
      s_{audio_old}=s_{audio_new}, Δt_{audio_old}=Δt_{audio_new}
      s_{audio_new}=s, Δt_{audio_new}=Δt_{audio}

As described above, the audio time modification notification unit 119 sets the Δt_{audio_new} before the update processing to the Δt_{audio_old}. The audio time modification notification unit 119 changes the update mode of the s_{audio_old} on the basis of the comparison result between the sequence number s and the s_{audio_new} and the comparison result between the modified time information Δt_{audio} and the Δt_{audio_new}. The audio time modification notification unit 119 sets the acquired sequence number s and modified time information Δt_{audio} to the (s_{audio_new}, Δt_{audio_new}).

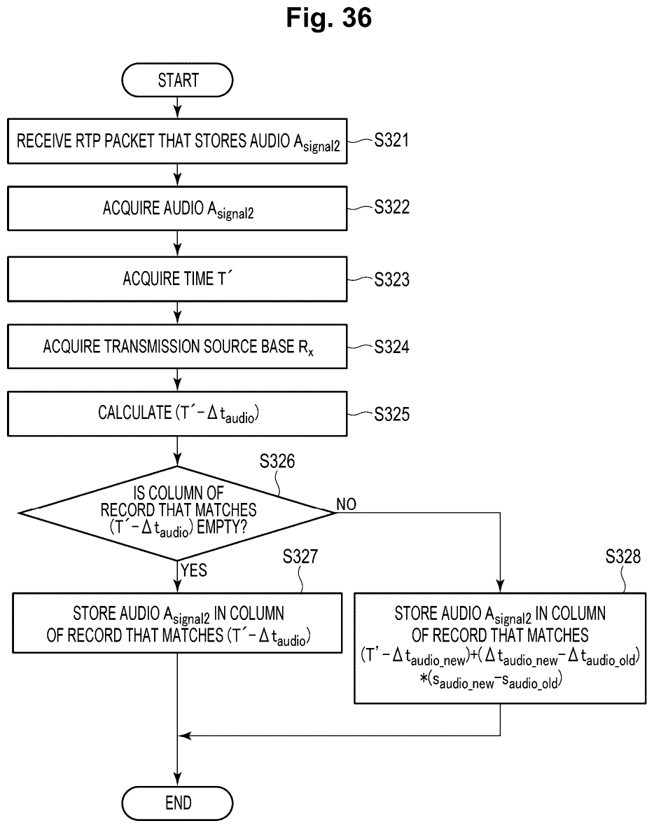

FIG. 36 is a flowchart illustrating a reception processing procedure and processing content of an RTP packet that stores an audio A_{signal2} of the server 1 in the base O according to the second embodiment. FIG. 36 illustrates the typical example of the processing of step S32 of the server 1.

The return audio reception unit 116 receives an RTP packet that stores an audio A_{signal2} sent out from the return audio transmission unit 216 via the IP network (step S321).

The return audio reception unit 116 acquires the audio A_{signal2} stored in the received RTP packet that stores the audio A_{signal2} (step S322).

The return audio reception unit 116 acquires a time T′ stored in an RTP time stamp of the received RTP packet that stores the audio A_{signal2} (step S323).

The return audio reception unit 116 acquires a transmission source base Rₓ (x is any one of 1, 2, . . . , and n) from information stored in the header of the received RTP packet that stores the audio A_{signal2} (step S324).

The return audio reception unit 116 calculates a time (T′−Δt_{audio}) obtained by subtracting a modified time information Δt_{audio} from a time T′ on the basis of the time T′ and the modified time information Δt_{audio} (step S325).

The return audio reception unit 116 refers to the audio synchronization control DB 132 and determines whether an audio data x column regarding the acquired transmission source base Rₓ is empty in a record in which a time T_{audio} matches the time (T′−Δt_{audio}) (step S326). In a case where the audio data x column regarding the transmission source base Rₓ is empty (YES in step S326), the processing proceeds from step S326 to step S327. In a case where the audio data x column regarding the transmission source base Rₓ is not empty (NO in step S326), the processing proceeds from step S326 to step S328.

The return audio reception unit 116 refers to the audio synchronization control DB 132 and stores the audio A_{signal2} in the audio data x column regarding the transmission source base Rₓ in the record in which the time T_{audio} matches the time (T′−Δt_{audio}) (step S327). The processing in step S327 is an example of storing the audio A_{signal2} in the audio synchronization control DB 132 in association with the time T_{audio} regarding the audio A_{signal2} on the basis of the time (T′−Δt_{audio}).

The return audio reception unit 116 refers to the audio synchronization control DB 132 and stores the audio A_{signal2} in the audio data x column regarding the transmission source base Rₓ in a record in which the time T_{audio} matches a time {(T′−Δt_{audio_new})+(Δt_{audio_new}−Δt_{audio_old})*(s_{audio_new}−s_{audio_old})} (step S328). The processing in step S328 is an example of storing the audio A_{signal2} in the audio synchronization control DB 132 in association with the time T_{audio} regarding the audio A_{signal2} on the basis of the time (T′−Δt_{audio}). Being based on the time (T′−Δt_{audio}) includes being based on the time {(T′−Δt_{audio_new})+(Δt_{audio_new}*(s_{audio_new}−s_{audio_old})} obtained by adding a modified time according to the acquisition history of the modified time information Δt_{audio} and the sequence number s to the time (T′−Δt_{audio}).

### (Effects)

As described above, in the second embodiment, the server 1 stores videos V_{signal2} in the video synchronization control DB 131 on the basis of times (T′−Δt_{video}). The server 1 simultaneously outputs videos V_{signal2} regarding a plurality of bases R associated with one time T_{video} stored in the video synchronization control DB 131 to the return video presentation device 102. The server 1 stores audios A_{signal2} in the audio synchronization control DB 132 on the basis of times (T′−Δt_{audio}). The server 1 simultaneously outputs audios A_{signal2} regarding a plurality of bases R associated with one time T_{audio} stored in the audio synchronization control DB 132 to the return audio presentation device 104.

As a result, the server 1 can associate videos V_{signal2} or audios A_{signal2} regarding the same acquisition time of videos V_{signal1} or audios A_{signal1} transmitted from a plurality of bases R at different timings with each other on the basis of times (T′−Δt_{video}) or times (T′−Δt_{audio}). The server 1 can simultaneously output videos V_{signal2} or audios A_{signal2} regarding a plurality of bases R associated with one acquisition time. The server 1 can appropriately synchronously reproduce a plurality of videos/audios that are returned and transmitted from a plurality of bases R through different transmission paths.

Furthermore, the server 1 receives an RTCP packet that stores modified time information Δt_{video} on the basis of change of the modified time information Δt_{video} by each of the servers of the bases R. The server 1 receives an RTCP packet that stores modified time information Δt_{audio} on the basis of change of the modified time information Δt_{audio} by each of the servers of the bases R. As a result, the server 1 can reduce a reception frequency of an RTCP packet that stores modified time information Δt_{video} or an RTCP packet that stores modified time information Δt_{audio}.

### Other Embodiments

The medium synchronization control device may be implemented by one device as described in the above examples, or may be implemented by a plurality of devices in which functions are distributed.

The program may be transferred in a state of being stored in an electronic device, or may be transferred in a state of not being stored in an electronic device. In the latter case, the program may be transferred via a network or may be transferred in a state of being recorded in a recording medium. The recording medium is a non-transitory tangible medium. The recording medium is a computer-readable medium. The recording medium is only required to be a medium that can store a program and can be read by a computer, such as a CD-ROM or a memory card, and any form can be used.

Although the embodiments of the present invention have been described in detail above, the above description is merely an example of the present invention in all respects. It goes without saying that various improvements and modifications can be made without departing from the scope of the present invention. That is, in carrying out the present invention, a specific configuration according to the embodiment may be appropriately employed.

In short, the present invention is not limited to the above-described embodiments without any change, and can be embodied by modifying the constituents without departing from the concept of the invention at the implementation stage. Various inventions can be implemented by appropriately combining a plurality of the constituents disclosed in the above-described embodiments. For example, some constituents may be omitted from all the constituents described in the embodiments. The constituents in different embodiments may be appropriately combined.

### REFERENCE SIGNS LIST

1 Server
2 Server
10 Time distribution server
11 Control unit
12 Program storage unit
13 Data storage unit
14 Communication interface
15 Input/output interface
21 Control unit
22 Program storage unit
23 Data storage unit
24 Communication interface
25 Input/output interface
101 Event video capturing device
102 Return video presentation device
103 Event audio recording device
104 Return audio presentation device
111 Time management unit
112 Event video transmission unit
113 Return video reception unit
114 Return video synchronization control unit
115 Event audio transmission unit
116 Return audio reception unit
117 Return audio synchronization control unit
118 Video time modification notification unit
119 Audio time modification notification unit
131 Video synchronization control DB
132 Audio synchronization control DB
201 Video presentation device
202 Offset video capturing device
203 Return video capturing device
204 Audio presentation device
205 Return audio recording device
211 Time management unit
212 Event video reception unit
213 Video offset calculation unit
214 Return video transmission unit
215 Event audio reception unit
216 Return audio transmission unit
217 Video time modification transmission unit
218 Audio time modification transmission unit
231 Video time management DB
232 Audio time management DB
O Base
R₁ to Rₙ Base
S Medium synchronization system

1. A medium synchronization control device of a first base, comprising:
a first receiver that receives, from an electronic device in each second base, a first packet that stores a second medium acquired in a second base at a time at which a first medium acquired at each time in the first base is reproduced in the second base, and stores the second medium in a memory in association with an acquisition time of the first medium regarding the second medium; and
medium synchronization control circuitry that simultaneously outputs the second medium regarding a plurality of second bases associated with one acquisition time stored in the memory to a presentation device.

2. The medium synchronization control device according to claim 1, further comprising:
a transmitter that transmits the first medium and a second packet that stores an acquisition time of the first medium to an electronic device in each second base,
wherein:
the first packet stores an acquisition time of the first medium regarding the second medium, and
the first receiver stores the second medium in the memory on a basis of an acquisition time of the first medium stored in the first packet.

3. The medium synchronization control device according to claim 1, further comprising:
a transmitter that transmits the first medium and a second packet that stores an acquisition time of the first medium to an electronic device in each second base; and
a second receiver that receives a third packet that stores a value of a difference between an acquisition time of the second medium and an acquisition time of the first medium in the second base from an electronic device in each second base,
wherein:
the first packet stores an acquisition time of the second medium in the second base, and
the first receiver stores the second medium in the memory on a basis of a time obtained by subtracting a value of the difference from an acquisition time of the second medium stored in the first packet.

4. The medium synchronization control device according to claim 3, wherein the second receiver receives the third packet on a basis of change of a value of the difference by an electronic device in the second base.

5. A medium synchronization control method, comprising:
receiving, from an electronic device in each second base, a first packet that stores a second medium acquired in a second base at a time at which a first medium acquired at each time in the first base is reproduced in the second base:
storing the second medium in a memory in association with an acquisition time of the first medium regarding the second medium; and
simultaneously outputting the second medium regarding a plurality of second bases associated with one acquisition time stored in the memory to a presentation device.

6. The medium synchronization control method according to claim 5, further comprising:
transmitting the first medium and a second packet that stores an acquisition time of the first medium to an electronic device in each second base,
wherein:
the first packet stores an acquisition time of the first medium regarding the second medium, and
the storing the second medium in the memory includes storing the second medium in the memory on a basis of an acquisition time of the first medium stored in the first packet.

7. The medium synchronization control method according to claim 5, further comprising:
transmitting the first medium and a second packet that stores an acquisition time of the first medium to an electronic device in each second base; and
receiving a third packet that stores a value of a difference between an acquisition time of the second medium and an acquisition time of the first medium in the second base from an electronic device in each second base,
wherein:
the first packet stores an acquisition time of the second medium in the second base, and
the storing the second medium in the memory includes storing the second medium in the memory on a basis of a time obtained by subtracting a value of the difference from an acquisition time of the second medium stored in the first packet.

8. A non-transitory computer readable medium storing a medium synchronization control program for causing a computer to perform processing by each of the circuitries of claim 1.

9. A non-transitory computer readable medium storing a medium synchronization control program for causing a computer to perform the method of claim 5.
